(19) United States
(12) Patent Application Publication
(10) Pub. No.: US 2022/0301527 A1
(43) Pub. Date: Sep. 22, 2022

(54) AUTOMATIC MUSICAL PERFORMANCE DEVICE, NON-TRANSITORY COMPUTER READABLE MEDIUM, AND AUTOMATIC MUSICAL PERFORMANCE METHOD

(71) Applicant: Roland Corporation, Shizuoka (JP)

(72) Inventors: Akihiro NAGATA, Shizuoka (JP); Takaaki HAGINO, Shizuoka (JP)

(73) Assignee: Roland Corporation, Shizuoka (JP)

(21) Appl. No.: 17/637,077

(22) PCT Filed: Sep. 4, 2019
(86) PCT No.: PCT/JP2019/034874

§ 371 Date: Feb. 22, 2022

(51) Int. Cl. G10H 1/00; G10H 1/18

(52) U.S. Cl. CPC G10H 1/0025; G10H 1/18; G10H 2210/325; G10H 2210/111; G10H 2210/341

(57) ABSTRACT

An automatic musical performance device includes: a storage part, storing musical performance patterns; a musical performance part, performing musical performance on the basis of the musical performance patterns stored in the storage part; an input part, to which musical performance information is input a setting part, setting a mode as to whether to switch the musical performance; a selection part, selecting a musical performance pattern estimated to have a maximum likelihood among the musical performance patterns stored in the storage part on the basis of the musical performance information input to the input part when a mode of switching the musical performance by the musical performance part is set by the setting part; and a switching part, switching at least one musical expression of the musical performance pattern played by the musical performance part to a musical expression of the musical performance pattern selected by the selection part.

### TECHNICAL FIELD

The present invention relates to an automatic musical performance device and an automatic musical performance program.

### BACKGROUND ART

In Patent Literature 1, a search device for automatic accompaniment data has been disclosed. In this device, when a user presses a keyboard of a rhythm input device 10, trigger data indicating the pressing of the keyboard, that is, carrying-out of a musical performance operation and velocity data indicating a strength of keyboard press, that is, a strength of this musical performance operation are input to an information processing device 20 as an input rhythm pattern using one bar as its unit.

The information processing device 20 has a database that includes a plurality of pieces of automatic accompaniment data. Each of the pieces of automatic accompaniment data is composed of a plurality of parts each having a unique rhythm pattern. When an input rhythm pattern is received as an input from the rhythm input device 10, the information processing device 20 searches for automatic accompaniment data having a rhythm pattern that is the same as or similar to the input rhythm pattern and displays a list of names and the like of retrieved automatic accompaniment data. The information processing device 20 outputs sounds based on automatic accompaniment data selected by a user from the displayed list.

In this way, in the device disclosed in Patent Literature 1, when automatic accompaniment data is selected, a user needs to input an input rhythm pattern and then select desired automatic accompaniment data from a displayed list, and thus the selection operation is complicated.

### CITATION LIST

### Patent Literature

Patent Literature 1: Japanese Patent Laid-Open No. 2012-234167

Patent Literature 2: Japanese Patent Laid-Open No. 2007-241181

### SUMMARY OF INVENTION

### Technical Problem

On the other hand, applicants of this application have developed an automatic musical performance device and a program thereof disclosed in Japanese Patent Application No. 2018-096439 (not publicly known). According to this device and the program, an output pattern is estimated from among a plurality of output patterns that are combinations of an accompaniment sound and an effect on the basis of musical performance information played (input) by a performer, and an accompaniment sound and an effect corresponding thereto are output. In other words, in accordance with a free musical performance of a performer, automatic musical performance of an accompaniment sound and an effect conforming to the musical performance can be performed.

However, according to the device and the program, automatic musical performance is changed on the basis of musical performance (input) carried out by a performer, and thus there is a problem in that even in a case in which a chord change is not desired at the time of carrying out solo musical performance or a case in which musical performance is desired to be carried out with a rhythm of drum musical performance or the like being constant, those are changed.

The present invention is for solving the problem described above, and an objective thereof is to provide an automatic musical performance device and an automatic musical performance program capable of carrying out automatic musical performance conforming to musical performance of a performer in accordance with the performer's intention.

### Solution to Problem

In order to achieve this objective, an automatic musical performance device according to the present invention includes: a storage part configured to store a plurality of musical performance patterns; a musical performance part configured to perform musical performance on the basis of the musical performance pattern stored in the storage part; an input part to which musical performance information is input from an input device receiving a musical performance operation of a performer; a setting part configured to set a mode as to whether to switch the musical performance by the musical performance part; a selection part configured to select a musical performance pattern estimated to have a maximum likelihood among the plurality of musical performance patterns stored in the storage part on the basis of the musical performance information input to the input part in a case in which a mode of switching the musical performance by the musical performance part is set by the setting part; and a switching part configured to switch at least one musical expression of the musical performance pattern played by the musical performance part to a musical expression of the musical performance pattern selected by the selection part.

Here, in addition to a keyboard or the like mounted on a main body of the automatic musical performance device, examples of the “input device”, for example, include a keyboard or the like of an external device configured separately from the automatic musical performance device.

An automatic musical performance program according to the present invention causes a computer including a storage to execute automatic musical performance. The automatic musical performance program is characterized by causing the computer to realize: causing the storage to function as a storage part configured to store a plurality of musical performance patterns; a performing step of performing musical performance on the basis of the musical performance pattern stored in the storage part; an inputting step in which musical performance information is input from an input device receiving a musical performance operation of a performer; a setting step of setting a mode as to whether to switch the musical performance by the performing step; a selecting step of selecting a musical performance pattern estimated to have a maximum likelihood among the plurality of musical performance patterns stored in the storage part on the basis of the musical performance information input by the inputting step in a case in which a mode of switching the musical performance by the performing step is set by the setting step; and a switching step of switching at least one musical expression of the musical performance pattern played by the performing step to a musical expression of the musical performance pattern selected by the selecting step.

For example, here, examples of the “input device” include a keyboard or the like that is connected in a wired or wireless manner to the computer in which the automatic musical performance program is installed.

### BRIEF DESCRIPTION OF DRAWINGS

FIG. 1 is an external appearance view of a synthesizer according to one embodiment.

FIG. 2 is a block diagram illustrating an electrical configuration of the synthesizer.

FIG. 3(a) is a schematic view illustrating beat positions of an accompaniment sound, and FIG. 3(b) is a table illustrating one example of an input pattern.

FIG. 4 is a table illustrating a state of an input pattern.

FIG. 5(a) is a diagram schematically illustrating an input pattern table, and FIG. 5(b) is a diagram schematically illustrating an output pattern table.

FIG. 6(a) is a diagram schematically illustrating a transition route, and FIG. 6(b) is a diagram schematically illustrating an inter-transition route likelihood table.

FIG. 7(a) is a diagram schematically illustrating a user evaluation likelihood table, FIG. 7(b) is a diagram schematically illustrating a pitch likelihood table, and FIG. 7(c) is a diagram schematically illustrating an accompaniment synchronization likelihood table.

FIG. 8(a) is a diagram schematically illustrating an IOI likelihood table, FIG. 8(b) is a diagram schematically illustrating a likelihood table, and FIG. 8(c) is a diagram schematically illustrating a previous-time likelihood table.

FIG. 9 is a flowchart of a main process.

FIG. 10 is a flowchart of a user evaluation reflecting process.

FIG. 11 is a flowchart of a key input process.

FIG. 12 is a flowchart of an input pattern search process.

FIG. 13 is a flowchart of a likelihood calculating process.

FIG. 14 is a flowchart of an inter-state likelihood integrating process.

FIG. 15 is a flowchart of an inter-transition likelihood integrating process.

FIG. 16 is a flowchart of a user evaluation likelihood integrating process.

### DESCRIPTION OF EMBODIMENTS

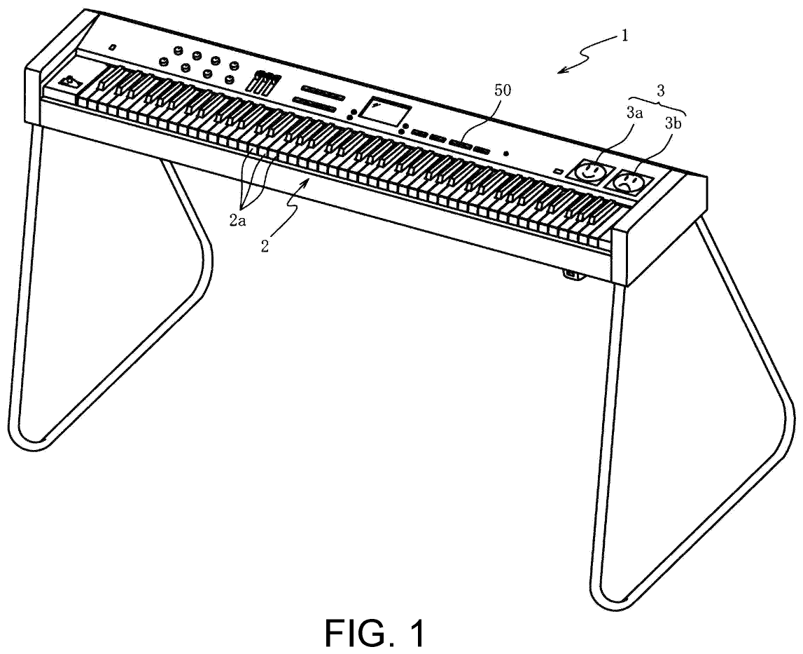

Hereinafter, preferred embodiments will be described with reference to the accompanying drawings. FIG. 1 is an external appearance view of a synthesizer 1 according to one embodiment. The synthesizer 1 is an electronic musical instrument (automatic musical performance device) that mixes and outputs (discharges) a musical sound according to a performance operation of a performer (user), a predetermined accompaniment sound, and the like. By performing an arithmetic processing on waveform data acquired by mixing a musical sound according to musical performance of a performer, an accompaniment sound, and the like, the synthesizer 1 can perform effects such as reverberation, a chorus, a delay, and the like.

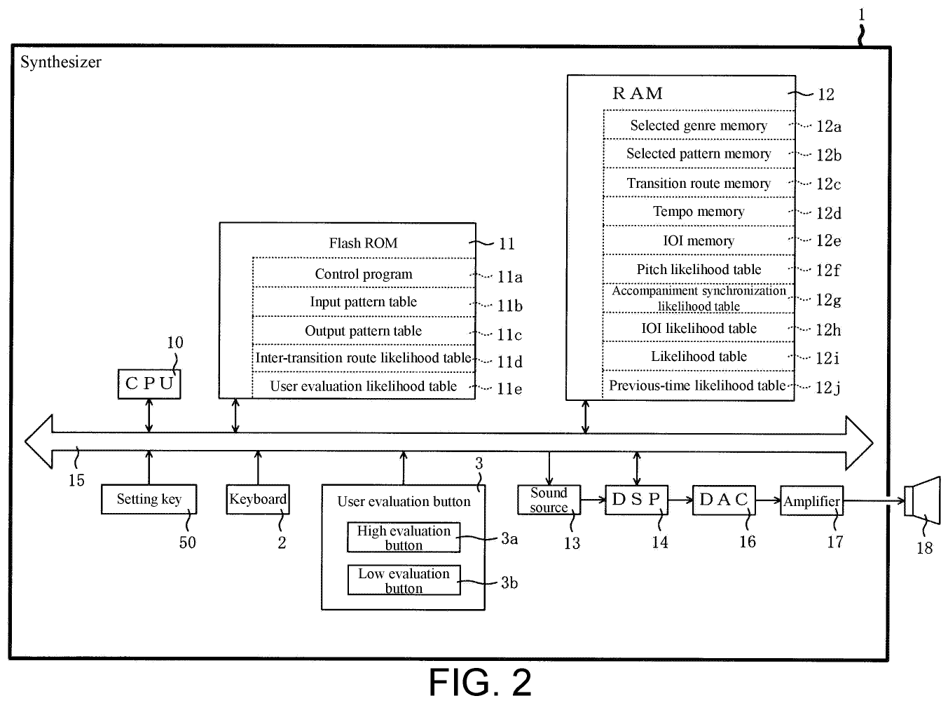

As illustrated in FIG. 1, in the synthesizer 1, mainly, a keyboard 2, a user evaluation button 3, and a setting key 50 are arranged. A plurality of keys 2a is arranged in the keyboard 2 and, the keyboard is an input device used for acquiring musical performance information according to musical performance of a performer. Musical performance information of a musical instrument digital interface (MIDI) standard according to a performer's pressing/releasing operation of the keys 2a is output to a CPU 10 (see FIG. 2).

The user evaluation button 3 is a button that outputs a performer's evaluation (a high evaluation value or a low evaluation value) of an accompaniment sound and an effect output from the synthesizer 1 to the CPU 10 and is composed of a high evaluation button 3a outputting information representing the high evaluation value of a performer to the CPU 10 and a low evaluation button 3b outputting information representing the low evaluation value of a performer to the CPU 10. For a performer, in a case in which an accompaniment sound and an effect output from the synthesizer 1 has a good impression, the high evaluation button 3a is pressed, and on the other hand, in a case in which an accompaniment sound and an effect output from the synthesizer 1 has a not so good impression or a bad expression, the low evaluation button 3b is pressed. Then, information representing the high evaluation value or the low evaluation value according to the high evaluation button 3a or the low evaluation button 3b that has been pressed is output to the CPU 10.

Although details will be described below, in the synthesizer 1 according to this embodiment, an output pattern is estimated on the basis of musical performance information from the key 2a according to a performer among a plurality of output patterns that are combinations of an accompaniment sound and an effect, and an accompaniment sound and an effect corresponding thereto are output. In this way, in accordance with the performer's free musical performance, an accompaniment sound and an effect conforming to the musical performance can be output. At that time, an output pattern of an accompaniment sound and an effect for which the high evaluation button 3a has been pressed many times by a performer is selected with a higher priority level. In this way, in accordance with the performer's free musical performance, an accompaniment sound and an effect conforming to the musical performance can be output.

The setting key 50 is an operator used for inputting various settings to the synthesizer 1. In accordance with the setting key 50, particularly, on/off of three modes relating to an accompaniment sound are set. More specifically, on/off of an accompaniment change setting for performing switching between accompaniment sounds in accordance with an input to the keyboard 2, on/off of a rhythm change setting for setting whether or not a beat position and a keying interval (input interval) are taken into account when switching between accompaniment sounds is performed, and on/off of a pitch change setting for setting whether or not a pitch input from the keyboard 2 is taken into account when switching between accompaniments is performed are set.

Next, an electrical configuration of the synthesizer 1 will be described with reference to FIGS. 2 to 8. FIG. 2 is a block diagram illustrating the electrical configuration of the synthesizer 1. The synthesizer 1 includes a CPU 10, a flash ROM 11, a RAM 12, a keyboard 2, a user evaluation button 3, a sound source 13, a digital signal processor 14 (hereinafter referred to as a “DSP 14”), and a setting key 50, which are connected through a bus line 15. A digital analog converter (DAC) 16 is connected to the DSP 14, an amplifier 17 is connected to the DAC 16, and a speaker 18 is connected to the amplifier 17.

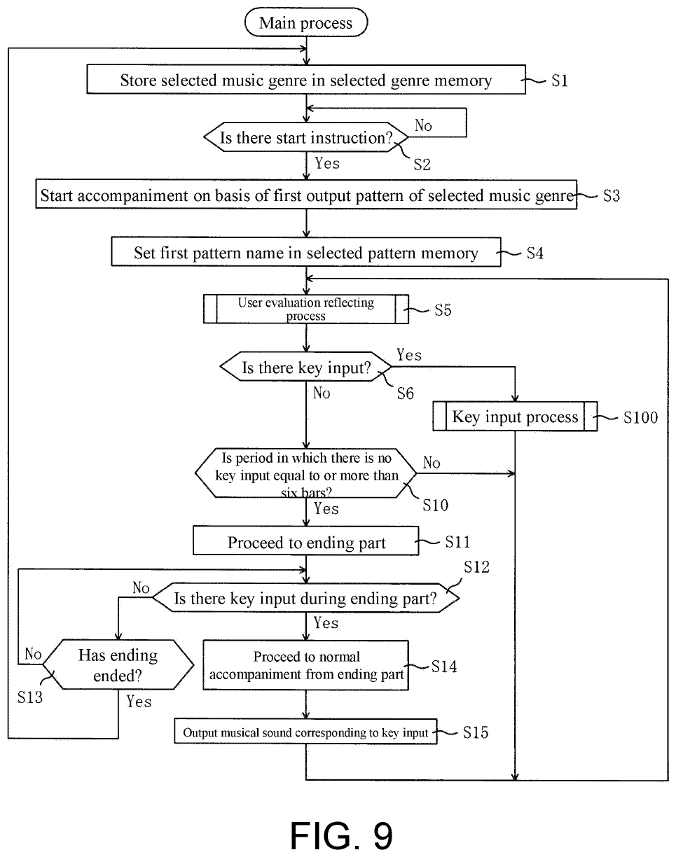

The CPU 10 is an arithmetic operation device that controls each part connected using the bus line 15. The flash ROM 11 is a rewritable nonvolatile memory and, a control program 11a, an input pattern table 11b, an output pattern table 11c, an inter-transition route likelihood table 11d, and a user evaluation likelihood table 11e are disposed therein. Waveform data corresponding to each key composing the keyboard 2 is stored in waveform data 23a. When the control program 11a is executed by the CPU 10, a main process illustrated in FIG. 9 is performed.

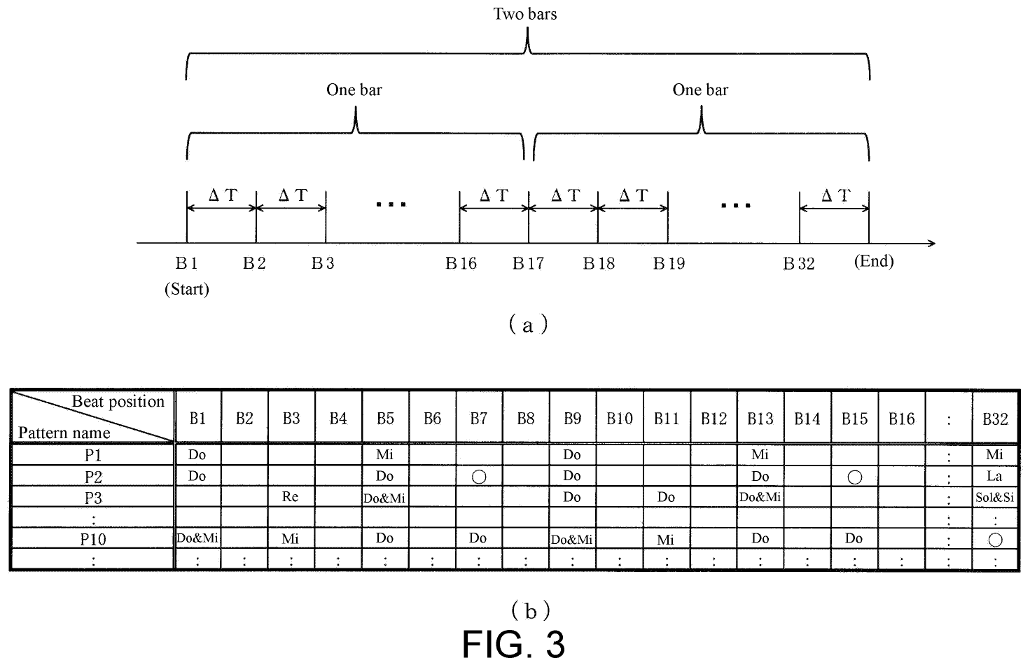

The input pattern table 11b is a data table in which musical performance information and an input pattern matching the musical performance information are stored. Here, beat positions, states, and pattern names of accompaniment sounds in the synthesizer 1 according to this embodiment will be described with reference to FIG. 3.

FIG. 3(a) is a schematic view illustrating beat positions of an accompaniment sound. In the synthesizer 1 according to this embodiment, a plurality of output patterns that are combinations of an accompaniment sound and an effect are stored, and an input pattern formed from a series of beat positions and pitches corresponding to each output pattern is set in the output pattern. A “most likely” input pattern is estimated for musical performance information from the key 2a according to a performer on the basis of the musical performance information from the key 2a according to the performer and beat positions and pitches of each input pattern, and an accompaniment sound and an effect of an output pattern corresponding to the input pattern are output. Hereinafter, a combination of an input pattern and an output pattern will be referred to as a “pattern”.

In this embodiment, as illustrated in FIG. 3(a), a performance time interval of an accompaniment sound of each output pattern is regarded to be a length corresponding to two bars in a four-four time. Beat positions B1 to B32 that are acquired by equally dividing this length corresponding to two bars by a length of a 16-divided musical note (in other words, by equally dividing the length into 32 parts) are set as one unit of time positions. A time ΔT illustrated in FIG. 3(a) represents the length of a 16-divided musical note. An input pattern is acquired by arranging pitches corresponding to an accompaniment sound and an effect of each output pattern in such beat positions B1 to B32. One example of such an input pattern is illustrated in FIG. 3(b).

FIG. 3(b) is a table illustrating one example of the input pattern. As illustrated in FIG. 3(b), pitches (do, re, mi, . . . ) for the beat positions B1 to B32 are set in the input pattern. Here, patterns P1, P2, . . . are identification names used for associating an input pattern with an output pattern to be described below.

Only single pitches are not respectively set to certain beat positions B1 to B32 in an input pattern, and a combination of two or more pitches may be designated thereto. In this embodiment, in a case in which simultaneous inputs of two or more pitches are designated, corresponding pitch names are connected using “&” for the beat positions B1 to B32. For example, while pitches “do & mi” are designated for the beat position B5 of an input pattern P3 in FIG. 3(b), this designates simultaneous inputs of “do” and “mi”.

In addition, any one pitch (a so-called a wildcard pitch) may be input to the beat positions B1 to B32. In this embodiment, in a case in which an input of a wildcard pitch is designated, “O” is designated for the beat positions B1 to B32. For example, for the beat position B7 of an input pattern P2 in FIG. 3(b), an input of a wildcard pitch is designated, and thus “O” is designated.

In addition, in an input pattern, pitches are defined for the beat positions B1 to B32 for which an input of musical performance information is designated, and on the other hand, pitches are not defined for the beat positions B1 to B32 for which an input of musical performance information is not designated.

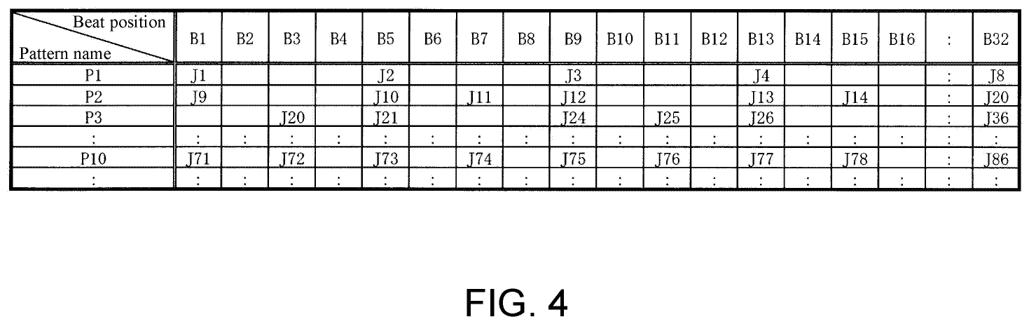

In this embodiment, since combinations of the beat positions B1 to B32 and pitches of an input pattern are managed, such a combination will be defined as a “state” of 1. Such a state of the input pattern will be described with reference to FIG. 4.

FIG. 4 is a table for illustrating states of input patterns. As illustrated in FIG. 4, states J1, J2, . . . are defined for beat positions B1 to B32 for which pitches are designated in order from the beat position B1 of the input pattern P1. More specifically, the beat position B1 of the input pattern P1 is defined as the state J1, the beat position B5 of the input pattern P1 is defined as the state J2, . . . , the beat position B32 of the input pattern P1 is defined as the state J8, and the beat position B1 of the input pattern P2 is defined as the state J9 following the state J8. Hereinafter, in a case in which the states J1, J2, . . . do not need to be distinguished from each other, they will be abbreviated to a “state Jn”.

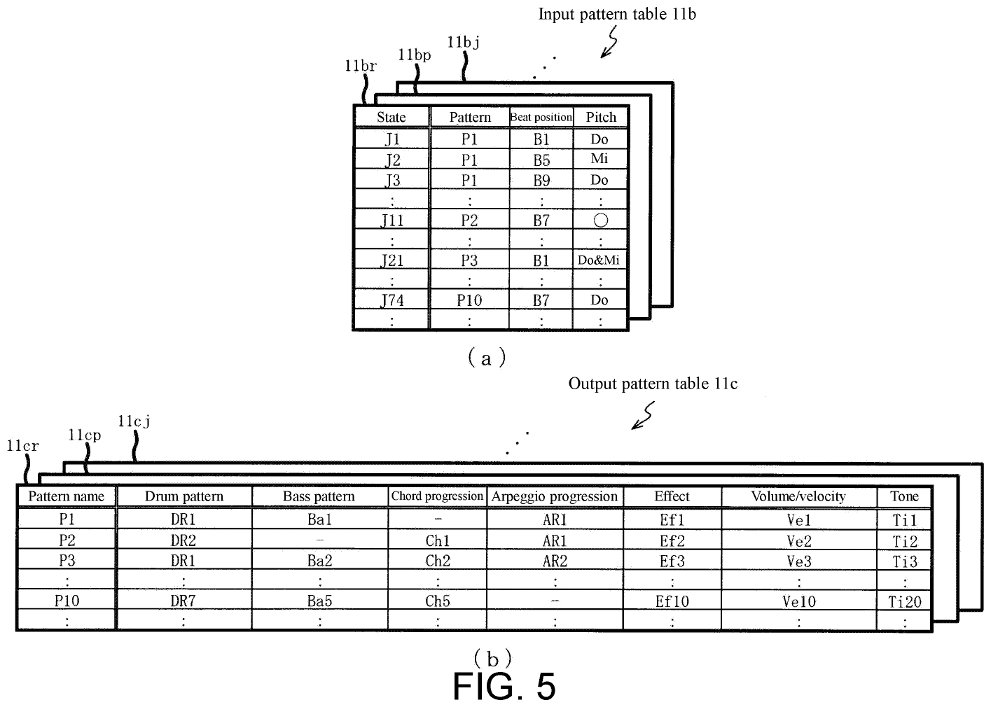

In the input pattern table 11b illustrated in FIG. 2, for each state Jn, a pattern name, beat positions B1 to B32, and pitches of a corresponding input pattern are stored. Such an input pattern table 11b will be described with reference to FIG. 5(a).

FIG. 5(a) is a diagram schematically illustrating the input pattern table 11b. The input pattern table 11b is a data table in which, for a music genre (rock, pop, jazz, or the like) that can be designated by the synthesizer 1, a pattern name, beat positions B1 to B32, and pitches of a corresponding input pattern are stored for each state Jn. In this embodiment, an input pattern for each music genre is stored in the input pattern table 11b, and an input pattern corresponding to a selected music genre in the input pattern table 11b is referred to.

More specifically, input patterns corresponding to the music genre “rock” are set in an input pattern table 11br, input patterns corresponding to the music genre “pop” are set in an input pattern table 11bp, and input patterns corresponding to the music genre “Jazz” are set in an input pattern table 11bj, and similarly, input patterns are stored for other music genres. Hereinafter, in a case in which the input pattern tables 11bp, 11br, 11bj, . . . in the input pattern table 11b do not particularly need to be distinguished from each other, they will be referred to as an “input pattern table 11bx”.

In a case in which musical performance information is input from the key 2a, the “most likely” state Jn is estimated from beat positions and pitches of the musical performance information and beat positions and pitches of the input pattern table 11bx corresponding to a selected music genre, an input pattern is acquired from the state Jn, and an accompaniment sound and an effect of an output pattern corresponding to a pattern name of the input pattern are output.

Description will return to FIG. 2. The output pattern table 11c is a data table in which output patterns that are combinations of an accompaniment sound and an effect for each pattern are stored. Such an output pattern table 11c will be described with reference to FIG. 5(b).

FIG. 5(b) is a diagram schematically illustrating the output pattern table 11c. Similar to the input pattern table 11b, an output pattern for each music genre is stored also in the output pattern table 11c. More specifically, in the output pattern table 11c, output patterns corresponding to the music genre “rock” are set in an output pattern table 11cr, output patterns corresponding to the music genre “pop” are set in an output pattern table 11cp, and output patterns corresponding to the music genre “Jazz” are set in an output pattern table 11cj, and similarly, output patterns are stored for other music genres. Hereinafter, in a case in which the output pattern tables 11cp, 11cr, 11cj, . . . in the output pattern table 11c do not particularly need to be distinguished from each other, they will be referred to as an “output pattern table 11cx”.

In the output pattern table 11cx, for each output pattern, a drum pattern in which a rhythm pattern of a drum as an accompaniment sound is stored, a bass pattern in which a rhythm pattern of a bass is stored, a chord progression in which a progression of chords is stored, an arpeggio progression in which a progression of arpeggio is stored, an effect in which forms of effects are stored, a volume/velocity in which volume/velocity values of a musical sound based on an accompaniment sound and the musical performance information from the key 2a according to a performer are stored, and a tone in which a tone of a musical sound based on the musical performance information from the key 2a according to a performer is stored are disposed.

As drum patterns, drum patterns DR1, DR2, . . . that are musical performance information of different drums are set in advance, and the drum patterns DR1, DR2, . . . are set for each output pattern. In addition, as bass patterns, bass patterns Ba1, Ba2, . . . that are musical performance information of different drums are set in advance, and the bass patterns Ba1, Ba2, . . . are set for each output pattern.

As chord progressions, chord progressions Ch1, Ch2, . . . that are musical performance information according to different chord progressions are set in advance, and the chord progressions Ch1, Ch2, . . . are set for each output pattern. In addition, as arpeggio progressions, arpeggio progressions AR1, AR2, . . . that are pieces of musical performance information according to different arpeggio progressions are set in advance, and the arpeggio progressions AR1, AR2, . . . are set for each output pattern.

The performance time interval of each of the drum patterns DR1, DR2, . . . , the bass patterns Ba1, Ba2, . . . , the chord progressions Ch1, Ch2, . . . , and the arpeggio progressions AR1, AR2, . . . , which is stored in the output pattern table 11cx as an accompaniment sound, is a length corresponding to two bars as described above. Such a length corresponding to two bars is also a general unit in a musical expression, and thus even in a case in which an accompaniment sound is repeatedly output with the same pattern continued, an accompaniment sound causing no strange feeling of a performer or the audience can be formed.

As effects, effects Ef1, Ef2, . . . of different forms are set in advance, and the effects Ef1, Ef2, . . . are set for each output pattern. As volumes/velocities, volumes/velocities Ve1, Ve2, . . . of different values are set in advance, and the volumes/velocities Ve1, Ve2, . . . are set for each output pattern. In addition, as tones, tones Ti1, Ti2, . . . according to different musical instruments and the like are set in advance, and the tones Ti1, Ti2, . . . are set for each output pattern.

Furthermore, a musical sound based on musical performance information from the key 2a is output on the basis of the tones Ti1, Ti2, . . . set in a selected output pattern, and the effects Ef1, Ef2, . . . and the volumes/velocities Ve1, Ve2, . . . set in the selected output pattern are applied to a musical sound and an accompaniment sound based on the musical performance information from the key 2a.

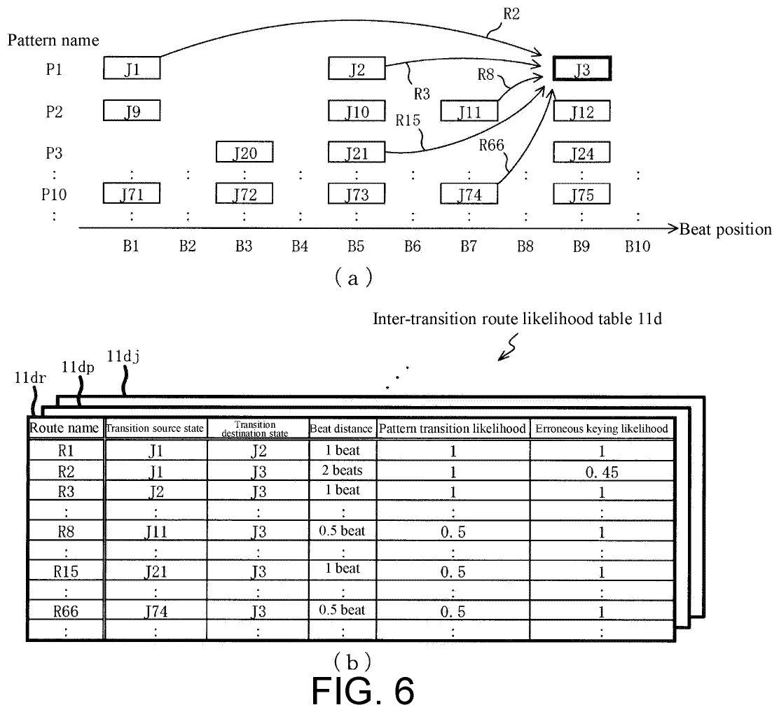

Description will return to FIG. 2. The inter-transition route likelihood table 11d is a data table in which the inter-state Jn transition route Rm, beat distances that are distances between the beat positions B1 to B32 of the transition route Rm, and a pattern transition likelihood and an erroneous keying likelihood for the transition route Rm are stored. Here, the transition route Rm and the inter-transition route likelihood table 11d will be described with reference to FIG. 6.

FIG. 6(a) is a diagram schematically illustrating the transition route Rm, and FIG. 6(b) is a diagram schematically illustrating the inter-transition route likelihood table 11d. In FIG. 6(a), the horizontal axis represents beat positions B1 to B32. As illustrated in FIG. 6(a), in accordance with elapse of the time, the beat position progresses from the beat position B1 to the beat position B32, and the state Jn of each pattern changes as well. In this embodiment, in a transition between such states Jn, a route between assumed states Jn is set in advance. Hereinafter, routes for transitions between states Jn set in advance will be referred to as “transition routes R1, R2, R3, . . . ”, and in a case in which these do not need to be distinguished from each other, they will be referred to as a “transition route Rm”.

FIG. 6(a) illustrates transition routes for a state J3. As transition routes to the state J3, when largely divided, two types of the case of a transition from a state Jn of the same pattern (in other words, a pattern P1) as the state J3 and the case of a transition from a state Jn of a pattern different from the state J3 are set.

In the same pattern P1 as the state J3, for a transition from the state Jn, a transition route R3 for a transition from a state J2 that is a previous state to the state J3 and a transition route R2 that is a transition route from a state J1 that is a state that is two states before the state J3 are set. In other words, in this embodiment, as transition routes to the state Jn between the same patterns, at most two transition routes including a transition route for a transition from the previous state Jn and a transition route of “sound skipping” for a transition from a state that is two states before are set.

On the other hand, as transition routes for a transition from a state Jn of a different pattern from the state J3, there are a transition route R8 for a transition from a state J11 of a pattern P2 to the state J3, a transition route R15 for a transition from a state J21 of a pattern P3 to the state J3, a transition route R66 for a transition from a state J74 of a pattern P10 to the state J3, and the like. In other words, as a transition route to the state Jn between different patterns, a transition route in which a state Jn of a different pattern that is a transition source thereof is immediately before a beat position of the state Jn of a transition destination is set.

In addition to the transition routes illustrated in FIG. 6(a), a plurality of transition routes Rm to the state J3 is set. In addition, similar to the state J3, one or a plurality of transition routes Rm is set also for each state Jn.

A “most likely” state Jn is estimated on the basis of the musical performance information from the key 2a, and an accompaniment sound and an effect according to an output pattern corresponding to an input pattern that corresponds to the state Jn are output. In this embodiment, the state Jn is estimated on the basis of musical performance information from the key 2a and a likelihood that is a numerical value indicating “most likelihood” of the state Jn that are set for each state Jn. In this embodiment, a likelihood for the state Jn is calculated by integrating a likelihood based on the state Jn and a likelihood based on the transition route Rm or a likelihood based on a pattern.

A pattern transition likelihood and an erroneous keying likelihood stored in the inter-transition route likelihood table 11dx are likelihoods based on the transition route Rm. More specifically, first, the pattern transition likelihood is a likelihood indicating whether a state Jn of a transition source and a state Jn of a transition destination for the transition route Rm are the same pattern. In this embodiment, in a case in which the states Jn of the transition source and the transition destination of the transition route Rm are the same pattern, “1” is set to the pattern transition likelihood. In a case in which the states Jn of the transition source and the transition destination of the transition route Rm are different patterns, “0.5” is set to the pattern transition likelihood.

For example, in FIG. 6(b), a transition route R3 has a transition source that is in the state J2 of the pattern P1 and a transition destination that is, similarly, in the state J3 of the pattern P1, and thus “1” is set to the pattern transition likelihood of the transition route R3. On the other hand, a transition route R8 has a transition source that is in the state J11 of the pattern P2 and a transition destination that is in the state J3 of the pattern P1, and thus the transition route R8 is a transition route between different patterns. Thus, “0.5” is set to the pattern transition likelihood of the transition route R8.

Regarding the pattern transition likelihood, a value larger than that of the pattern transition likelihood of the transition route Rm for different patterns is set to the pattern transition likelihood of the transition route Rm for the same patterns. The reason for this is that the probability of staying at the same pattern is higher than the probability of transitioning to a different pattern in an actual musical performance. Thus, a state Jn of a transition destination in a transition route Rm to the same pattern is estimated with priority over a state Jn of a transition destination in a transition route Rm to a different pattern, and thus a transition to a different pattern is inhibited, and the output pattern can be inhibited from being frequently changed. In accordance with this, an accompaniment sound and an effect can be inhibited from being frequently changed, and thus an accompaniment sound and an effect causing a little feeling of strangeness for a performer and the audience can be formed.

In addition, an erroneous keying likelihood stored in the inter-transition route likelihood table 11dx is a likelihood indicating whether the state Jn of the transition source and the state Jn of the transition destination for the transition route Rm are the same patterns, and the state Jn of the transition source is the state Jn that is two states before the state Jn of the transition destination, in other words, whether the state Jn of the transition source and the state Jn of the transition destination for the transition route Rm form a transition route according to sound skipping. In this embodiment, “0.45” is set to the erroneous keying likelihood for a transition route Rm in which states Jn of the transition source and the transition destination of the transition route Rm form a transition route Rm according to sound skipping. On the other hand, “1” is set to the erroneous keying likelihood in a case in which the states do not form a transition route Rm according to sound skipping.

For example, in FIG. 6(b), a transition route R1 is a transition route between adjacent states J1 and J2 in the same pattern P1 but is not a transition route according to sound skipping, and thus “1” is set to the erroneous keying likelihood. On the other hand, in a transition route R2, a state J3 of the transition destination is a state that is two states before a state J1 of the transition source, and thus “0.45” is set to the erroneous keying likelihood.

As described above, in the same pattern, a transition route Rm according to sound skipping in which a state Jn that is two states before the state Jn of the transition destination is the state Jn of the transition source is also set. In an actual musical performance, a probability of occurrence of a transition according to sound skipping is lower than a probability of occurrence of a normal transition. Thus, by setting a value smaller than the erroneous keying likelihood of a normal transition route Rm other than sound skipping to the erroneous keying likelihood of a transition route Rm according to sound skipping, similar to an actual musical performance, the state Jn of the transition destination of the normal transition route Rm can be estimated with priority over a state Jn of the transition destination of the transition route Rm according to sound skipping.

In addition, as illustrated in FIG. 6(b), in the inter-transition route likelihood table 11d, for each music genre designated by the synthesizer 1, for each transition route Rm, a state Jn of a transition source, a state Jn of a transition destination, a pattern transition likelihood, and an erroneous keying likelihood of the transition route Rm are stored in association with each other. In this embodiment, also as the inter-transition route likelihood table 11d, an inter-transition route likelihood table is stored for each music genre. Thus, an inter-transition route likelihood table corresponding to the music genre “rock” is set as an inter-transition route likelihood table 11dr, an inter-transition route likelihood table corresponding to the music genre “pop” is set as an inter-transition route likelihood table 11dp, an inter-transition route likelihood table corresponding to the music genre “jazz” is set as an inter-transition route likelihood table 11dj, and inter-transition route likelihood tables are defined also for other music genres. Hereinafter, in a case in which inter-transition route likelihood tables 11dp, 11dr, 11dj, . . . in the inter-transition route likelihood table 11d do not need to be particularly distinguished from each other, they will be referred to as an “inter-transition route likelihood table 11dx”.

Description will return to FIG. 2. The user evaluation likelihood table 11e is a data table storing an evaluation result for an output pattern during performer's musical performance.

A user evaluation likelihood is a likelihood that is set for each pattern on the basis of an input from the user evaluation button 3 described above with reference to FIG. 1. More specifically, in a case in which the high evaluation button 3a (FIG. 1) of the user evaluation button 3 is pressed by a performer for an accompaniment sound and an effect that are being output, “0.1” is added to the user evaluation likelihood of a pattern corresponding to the accompaniment sound and the effect that are being output. On the other hand, in a case in which the low evaluation button 3b (FIG. 1) of the user evaluation button 3 is pressed by a performer for an accompaniment sound and an effect that are being output, “0.1” is subtracted from the user evaluation likelihood of a pattern corresponding to the accompaniment sound and the effect that are being output.

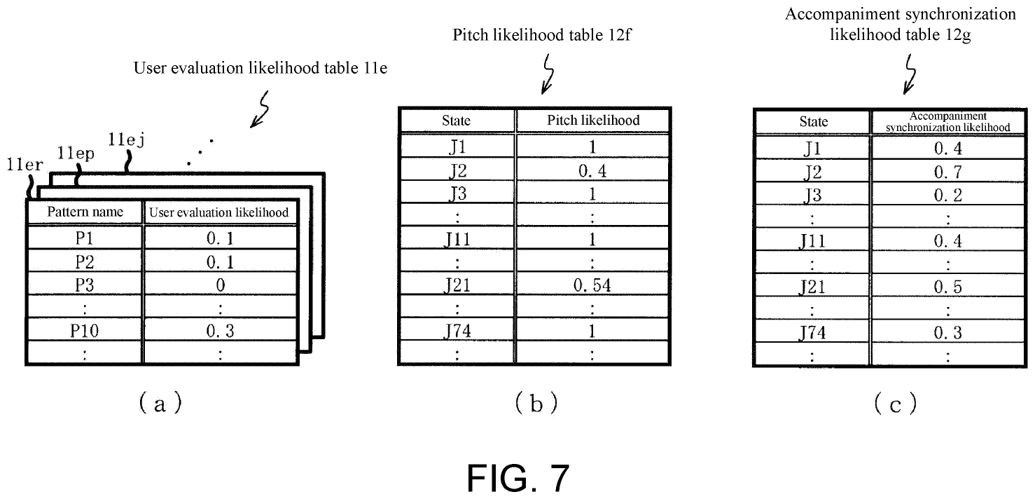

In other words, a higher user evaluation likelihood is set to a pattern of an accompaniment sound and an effect for which a high evaluation has been received by a performer, and a lower user evaluation likelihood is set to a pattern of an accompaniment sound and an effect for which a low evaluation has been received by a performer. Then, the user evaluation likelihood is applied to a likelihood of a state Jn corresponding to the pattern, and the state Jn of the musical performance information from the key 2a is estimated on the basis of the user evaluation likelihood for each state Jn. Thus, an accompaniment sound and an effect according to a pattern for which a higher evaluation has been received by a performer are output with priority, and thus an accompaniment sound and an effect based on a performer's preference for musical performance can be output with a higher probability. The user evaluation likelihood table 11e in which user evaluation likelihoods are stored will be described with reference to FIG. 7(a).

FIG. 7(a) is a diagram schematically illustrating the user evaluation likelihood table 11e. The user evaluation likelihood table 11e is a data table in which a user evaluation likelihood based on a performer's evaluation is stored for each pattern for music genres (rock, pop, jazz, and the like). In this embodiment, in the user evaluation likelihood table 11e, a user evaluation likelihood table corresponding to the music genre “rock” is set as a user evaluation likelihood table 11er, a user evaluation likelihood table corresponding to the music genre “pop” is set as a user evaluation likelihood table 11ep, a user evaluation likelihood table corresponding to the music genre “jazz” is set as a user evaluation likelihood table 11ej, and user evaluation likelihood tables are defined also for other music genres. Hereinafter, in a case in which the user evaluation likelihood tables 11ep, 11er, 11ej, . . . in the user evaluation likelihood table 11e do not particularly need to be distinguished from each other, they will be referred to as a “user evaluation likelihood table 11ex”.

Description will return to FIG. 2. The RAM 12 is a memory that rewritably stores various kinds of work data, flags, and the like when the CPU 10 executes a program such as the control program 11a and includes a selected genre memory 12a in which a music genre selected by a performer is stored, a selected pattern memory 12b in which an estimated pattern is stored, a transition route memory 12c in which an estimated transition route Rm is stored, a tempo memory 12d, an IOI memory 12e in which a time from a timing at which the key 2a was pressed at the previous time to a timing at which the key 2a is pressed this time (in other words, a keying interval) is stored, a pitch likelihood table 12f, an accompaniment synchronization likelihood table 12g, an IOI likelihood table 12h, a likelihood table 12i, and a previous-time likelihood table 12j.

The tempo memory 12d is a memory in which an actual time per beat of an accompaniment sound is stored. Hereinafter, the actual time per beat of an accompaniment sound will be referred to as a “tempo”, and the accompaniment sound is played on the basis of such a tempo.

The pitch likelihood table 12f is a data table in which a pitch likelihood that is a likelihood representing a relation between a pitch of musical performance information from the key 2a and a pitch of the state Jn is stored. In this embodiment, as a pitch likelihood, “1” is set in a case in which the pitch of the musical performance information from the key 2a and the pitch of the state Jn of the input pattern table 11bx (FIG. 5(a)) completely match each other, “0.54” is set in a case in which the pitches partly match each other, and “0.4” is set in a case in which the pitches do not match each other. In a case in which musical performance information from the key 2a is input, such a pitch likelihood is set to all the states Jn.

FIG. 7(b) illustrates a case in which “do” is input as a pitch of the musical performance information from the key 2a in the input pattern table 11br of the music genre “rock” illustrated in FIG. 5(a). Since the pitches of the state J1 and the state J74 are “do” in the input pattern table 11br, “1” is set to the pitch likelihood of the state J1 and the state J74 in the pitch likelihood table 12f. In addition, the pitch of the state J11 in the input pattern table 11br is a wild-card pitch, and thus even when any pitch is input, complete match is assumed. Thus, “1” is set also to the pitch likelihood of the state J11 in the pitch likelihood table 12f.

The pitch of the state J2 in the input pattern table 11br is “re” and does not match “do” that is a pitch of the musical performance information from the key 2a, and thus “0.4” is set to the state J2 in the pitch likelihood table 12f. In addition, the pitch of the state J21 in the input pattern table 11br is “do & mi” and partly matches “do” that is a pitch of the musical performance information from the key 2a, and thus “0.54” is set to the state J21 in the pitch likelihood table 12f. On the basis of the pitch likelihood table 12f set in this way, a state Jn of the pitch closest to the pitch of the musical performance information from the key 2a can be estimated.

Description will return to FIG. 2. The accompaniment synchronization likelihood table 12g is a data table in which each accompaniment synchronization likelihood that is a likelihood representing a relation between timings in two bars at which musical performance information from the key 2a is input and the beat positions B1 to B32 of the state Jn is stored. The accompaniment synchronization likelihood table 12g will be described with reference to FIG. 7(c).

FIG. 7(c) is a diagram schematically illustrating the accompaniment synchronization likelihood table 12g. As illustrated in FIG. 7(c), an accompaniment synchronization likelihood for each state Jn is stored in the accompaniment synchronization likelihood table 12g. In this embodiment, an accompaniment synchronization likelihood is calculated on the basis of a Gaussian distribution represented in Equation 2 to be described below from a difference between timings in two bars at which musical performance information from the key 2a is input and the beat positions B1 to B32 of the state Jn stored in the input pattern table 11bx.

More specifically, an accompaniment synchronization likelihood having a large value is set to a state Jn of the beat positions B1 to B32 having a small difference from the timings at which the musical performance information from the key 2a is input, and, on the other hand, an accompaniment synchronization likelihood having a small value is set to a state Jn of the beat positions B1 to B32 having a large difference from the timings at which the musical performance information from the key 2a is input. By estimating the state Jn for the musical performance information from the key 2a on the basis of the accompaniment synchronization likelihood of the accompaniment synchronization likelihood table 12g set in this way, the state Jn of the beat positions closest to timings at which the musical performance information from the key 2a is input can be estimated.

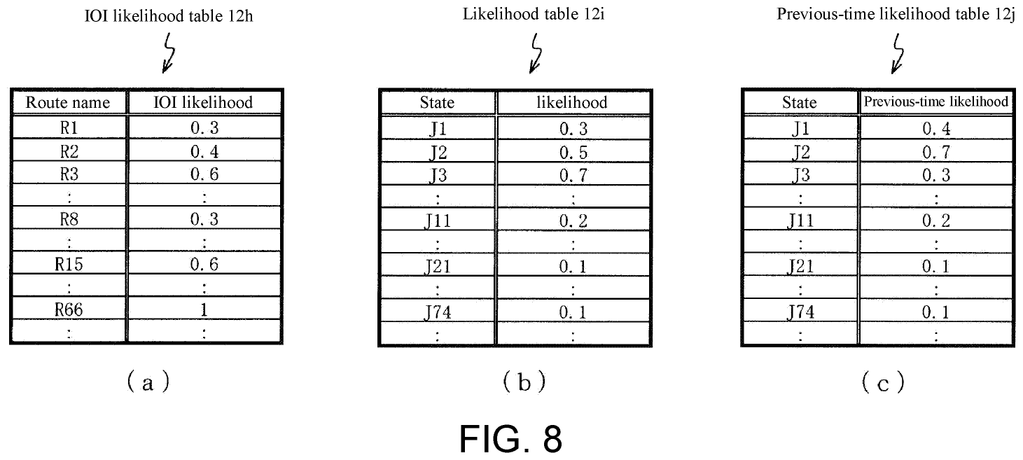

Description will return to FIG. 2. The IOI likelihood table 12h is a data table in which an IOI likelihood representing a relation between a keying interval stored in the IOI memory 12e and a beat distance of the transition route Rm stored in the inter-transition route likelihood table 11dx is stored. The IOI likelihood table 12h will be described with reference to FIG. 8(a).

FIG. 8(a) is a diagram schematically illustrating the IOI likelihood table 12h. As illustrated in FIG. 8(a), an IOI likelihood for each transition route Rm is stored in the IOI likelihood table 12h. In this embodiment, the IOI likelihood is calculated using Equation 1 to be described below from the keying interval stored in the IOI memory 12e and the beat distance of the transition route Rm stored in the inter-transition route likelihood table 11dx.

More specifically, an IOI likelihood having a large value is set to a transition route Rm of beat distances having a small difference from the keying interval stored in the IOI memory 12e, and, on the other hand, an IOI likelihood having a small value is set to a transition route Rm of beat distances having a large difference from the keying interval stored in the IOI memory 12e. By estimating the state Jn of the transition destination of the transition route Rm on the basis of the IOI likelihood of the transition route Rm set in this way, a state Jn based on the transition route Rm of beat distances assumed to be closest to the keying interval stored in the IOI memory 12e can be estimated.

Description will return to FIG. 2. The likelihood table 12i is a data table storing a likelihood that is a result of integrating the pattern transition likelihood, the erroneous keying likelihood, the user evaluation likelihood, the pitch likelihood, the accompaniment synchronization likelihood, and the IOI likelihood described above for each state Jn, and the previous-time likelihood table 12j is a data table storing a previous-time value of the likelihood for each state Jn stored in the likelihood table 12i. The likelihood table 12i and the previous-time likelihood table 12j will be described with reference to FIGS. 8(b) and 8(c).

FIG. 8(b) is a diagram schematically illustrating the likelihood table 12i, and FIG. 8(c) is a diagram schematically illustrating the previous-time likelihood table 12j. As illustrated in FIG. 8(b), a result acquired by integrating the pattern transition likelihood, the erroneous keying likelihood, the user evaluation likelihood, the pitch likelihood, the accompaniment synchronization likelihood, and the IOI likelihood for each state Jn is stored in the likelihood table 12i. Among these likelihoods, regarding the pattern transition likelihood, the erroneous keying likelihood, and the IOI likelihood, likelihoods of a transition route Rm corresponding to the state Jn of the transition destination are integrated, and, regarding the user evaluation likelihood, user evaluation likelihoods of a pattern of the corresponding state Jn are integrated. In addition, a likelihood of each state Jn that is acquired through integration of the previous time and is stored in the likelihood table 12i is stored in the previous-time likelihood table 12j illustrated in FIG. 8(c).

Description will return to FIG. 2. The sound source 13 is a device that outputs waveform data corresponding to musical performance information input from the CPU 10. The DSP 14 is an arithmetic operation device used for performing an arithmetic operation process on waveform data input from the sound source 13. An effect of an output pattern designated in the selected pattern memory 12b is applied to the waveform data input from the sound source 13 by using the DSP 14.

The DAC 16 is conversion device that converts the waveform data input from the DSP 14 into analog waveform data. The amplifier 17 is an amplification device that amplifies the analog waveform data output from the DAC 16 with a predetermined gain, and the speaker 18 is an output device that discharges (outputs) the analog waveform data amplified by the amplifier 17 as a musical sound.

Next, a main process performed by the CPU 10 will be described with reference to FIGS. 9 to 16. FIG. 9 is a flowchart of the main process. The main process is performed when power is input to the synthesizer 1.

In the main process, first, a music genre selected by a performer is stored in the selected genre memory 12a (S1). More specifically, a music genre is selected in accordance with a performer's operation on a music genre selection button (not illustrated) of the synthesizer 1, and the kind of the music genre is stored in the selected genre memory 12a.

In addition, for the input pattern table 11b, the output pattern table 11c, the inter-transition route likelihood table 11d or the user evaluation likelihood table 11e stored in each music genre, while the input pattern table 11bx, the output pattern table 11cx, the inter-transition route likelihood table 11dx or the user evaluation likelihood table 11ex corresponding to a music genre stored in this selected genre memory 12a is referred to, hereinafter, “a music genre stored in the selected genre memory 12a” will be referred to as a “corresponding music genre”.

After the process of S1, it is checked whether there is a start instruction from a performer (S2). This start instruction is output to the CPU 10 in a case in which a start button (not illustrated) disposed in the synthesizer 1 is selected. In a case in which there is no start instruction from the performer (S2: No), the process of S2 is repeated for waiting for a start instruction.

In a case in which there is a start instruction from the performer (S2: Yes), an accompaniment is started on the basis of a first output pattern of the corresponding music genre (S3). More specifically, musical performance of the accompaniment sound starts on the basis of the first output pattern of the output pattern table 11cx (FIG. 5(b)) of the corresponding music genre, that is, the drum pattern, the bass pattern, the chord progression, the arpeggio progression, the effect, the volume/velocity, and the tone of the output pattern of the pattern P1. At this time, a tempo defined in the selected output pattern is stored in the tempo memory 12d, and the accompaniment sound is played on the basis of the tempo.

After the process of S3, a pattern P1 is set in the selected pattern memory in accordance with start of the accompaniment sound based on the output pattern of the pattern P1 in the music genre according to the process of S3 (S4).

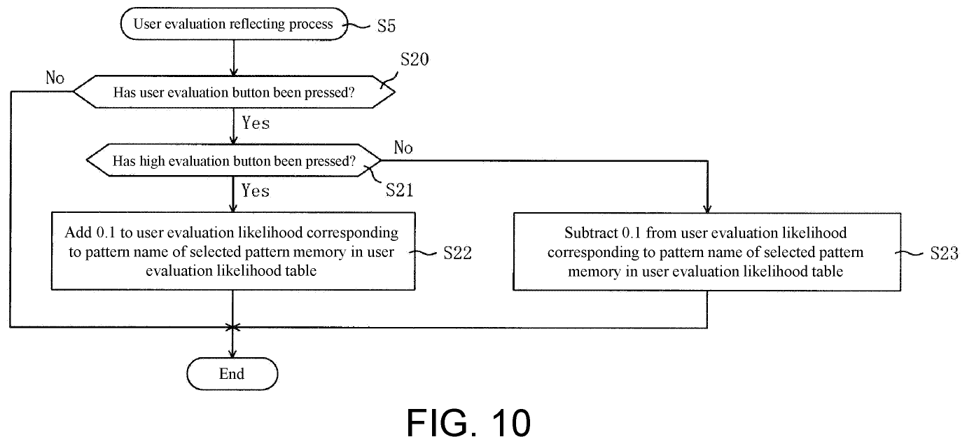

After the process of S4, a user evaluation reflecting process is performed (S5). Here, the user evaluation reflecting process will be described with reference to FIG. 10.

FIG. 10 is a flowchart of the user evaluation reflecting process. In the user evaluation reflecting process, first, it is checked whether the user evaluation button 3 (see FIG. 1) has been pressed (S20). In a case in which the user evaluation button 3 has been pressed (S20: Yes), it is further checked whether the high evaluation button 3a has been pressed (S21).

In the process of S21, in a case in which the high evaluation button 3a has been pressed (S21: Yes), 0.1 is added to a user evaluation likelihood corresponding to the pattern stored in the selected pattern memory 12b in the user evaluation likelihood table 11e (S22). In addition, in a case in which the user evaluation likelihood after addition is larger than 1 in the process of S22, 1 is set to the user evaluation likelihood.

On the other hand, in a case in which low evaluation button 3b has been pressed in the process of S21 (S21: No), 0.1 is subtracted from a user evaluation likelihood corresponding to the pattern stored in the selected pattern memory 12b in the user evaluation likelihood table 11e (S23). In addition, in a case in which the user evaluation likelihood after subtraction is smaller than 0 in the process of S23, 0 is set to the user evaluation likelihood.

In addition, in a case in which the user evaluation button 3 has not been pressed in the process of S20 (S20: No), the processes of S21 to S23 are skipped. Then, after the processes of S20, S22, and S23, the user evaluation reflecting process ends, and the process is returned to the main process.

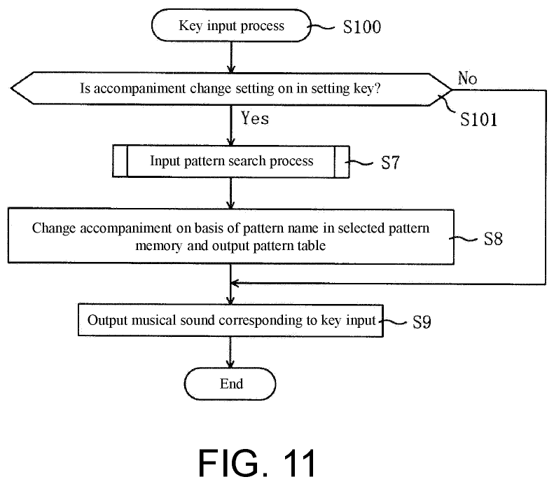

Description will return to FIG. 9. After the user evaluation reflecting process of S5, it is checked whether there is a key input, in other words, whether musical performance information from the key 2a has been input (S6). In a case in which musical performance information from the key 2a has been input in the process of S6 (S6: Yes), a key input process is performed (S100). Here, the key input process will be described with reference to FIGS. 11 to 16.

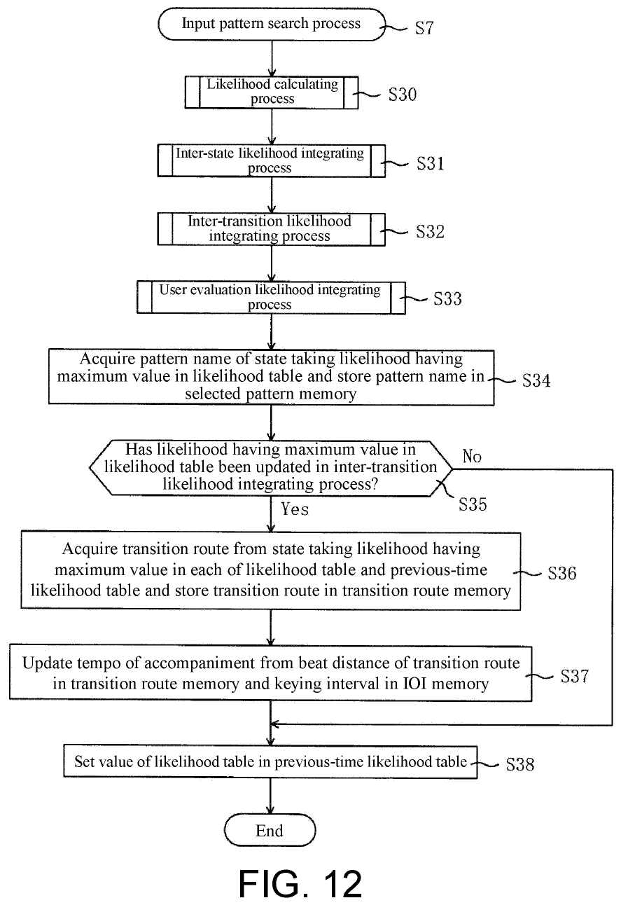

FIG. 11 is a flowchart of the key input process. In the key input process, first, a setting state of the setting key 50 (FIGS. 1 and 2) is checked, and it is checked whether an accompaniment change setting is on (S101). In the process of S101, in a case in which the accompaniment change setting is on (S101: Yes), an input pattern search process is performed (S7). Here, the input pattern search process will be described with reference to FIG. 12.

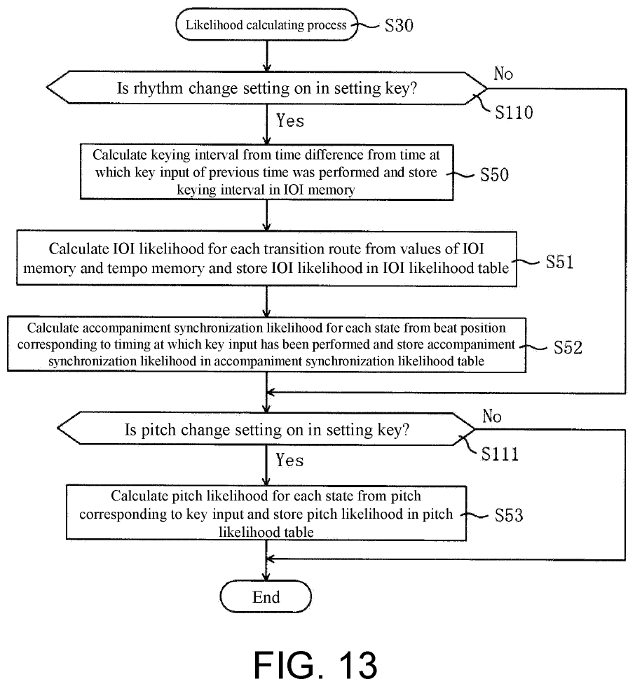

FIG. 12 is a flowchart of the input pattern search process. In the input pattern search process, first, a likelihood calculating process is performed (S30). The likelihood calculating process will be described with reference to FIG. 13.

FIG. 13 is a flowchart of the likelihood calculating process. In the likelihood calculating process, first, a setting state of the setting key 50 is checked, and it is checked whether the rhythm change setting is on (S110). In the process of S110, in a case in which the rhythm change setting is on (S110: Yes), a time difference between inputs of musical performance information from the key 2a, that is, a keying interval is calculated on the basis of a difference between a time at which an input of musical performance information of the previous time from the key 2a was performed and a time at which an input of musical performance information of this time from the key 2a has been performed and stores the keying interval in the IOI memory 12e (S50).

After the process of S50, an IOI likelihood is calculated on the basis of the keying interval stored in the IOI memory 12e, the tempo stored in the tempo memory 12d, and a beat distance of each transition route Rm in the inter-transition route likelihood table 11dx of the corresponding music genre and stores the calculated IOI likelihood in the IOI likelihood table 12h (S51). More specifically, when the keying interval stored in the IOI memory 12e is denoted by x, the tempo stored in the tempo memory 12d is denoted by Vm, and a beat distance of a certain transition route Rm, which is stored in the inter-transition route likelihood table 11dx, is denoted by Δτ, the IOI likelihood G is calculated using the Gaussian distribution represented in Equation 1.

$$\begin{matrix}[ Math 1 ] & \\ G = \frac{1}{\sqrt{2 π σ}} exp ( - \frac{{\frac{x}{Vm} - Δ τ )}^{2}}{2 {σ}^{2}} & ( Equation 1 )\end{matrix}$$

Here, σ is a constant representing a standard deviation of the Gaussian distribution represented in Equation 1, and a value calculated in advance in an experiment or the like is set. Such IOI likelihoods G are calculated for all the transition routes Rm, and results thereof are stored in the IOI likelihood table 12h. In other words, since the IOI likelihood G follows the Gaussian distribution represented in Equation 1, an IOI likelihood G having a larger value is set when a transition route Rm has a beat distance having a smaller difference from the keying interval stored in the IOI memory 12e.

After the process of S51, an accompaniment synchronization likelihood is calculated on the basis of a beat position corresponding to a time at which musical performance information from the key 2a has been input and a beat position in the input pattern table 11bx of the corresponding music genre and is stored in the accompaniment synchronization likelihood table 12g (S52). More specifically, when a result of conversion of the time at which the musical performance information from the key 2a has been input into a beat position in units of two bars is denoted by tp, and a beat position stored in the input pattern table 11bx of the corresponding music genre is denoted by τ, the accompaniment synchronization likelihood B is calculated using the Gaussian distribution represented in Equation 2.

$$\begin{matrix}[ Math 2 ] & \\ B = \frac{1}{\sqrt{2 π σ}} exp ( - \frac{{( tp - τ )}^{2}}{2 {ρ}^{2}} ) & ( Equation 2 )\end{matrix}$$

Here, ρ is a constant representing a standard deviation of the Gaussian distribution represented in Equation 2, and a value calculated in advance in an experiment or the like is set. Such accompaniment synchronization likelihoods B are calculated for all the states Jn, and results thereof are stored in the accompaniment synchronization likelihood table 12g. In other words, since the accompaniment synchronization likelihood B follows the Gaussian distribution represented in Equation 2, an accompaniment synchronization likelihood B having a larger value is set when a state Jn has a beat position having a smaller difference from a beat position corresponding to the time at which the musical performance information from the key 2a has been input.

On the other hand, in a case in which the rhythm change setting is off in the process of S110 (S110: No), the processes of S50 to S52 are skipped. After the processes of S52 and S110, the setting state of the setting key 50 is checked, and it is checked whether the pitch change setting is on (S111).

In a case in which the pitch change setting is on in the process of S110 (S111: Yes), a pitch likelihood is calculated for each state Jn on the basis of the pitch of the musical performance information from the key 2a and is stored in the pitch likelihood table 12f (S53). As described above with reference to FIG. 7(b), the pitch of the musical performance information from the key 2a and the pitch of each state Jn in the input pattern table 11bx of the corresponding music genre are compared with each other, “1” is set to the pitch likelihood of the corresponding state Jn in the pitch likelihood table 12f for the state Jn that completely matches the pitch, “0.54” is set to the pitch likelihood of the corresponding state Jn in the pitch likelihood table 12f for the state Jn that partly matches the pitch, and “0.4” is set to the pitch likelihood of the corresponding state Jn in the pitch likelihood table 12f for the state Jn that does not match the pitch.

On the other hand, in a case in which the pitch change setting is off in the process of S111 (S111: No), the process of S53 is skipped. After the processes of S53 and S111, the likelihood calculating process ends, and the process is returned to the input pattern search process illustrated in FIG. 12.

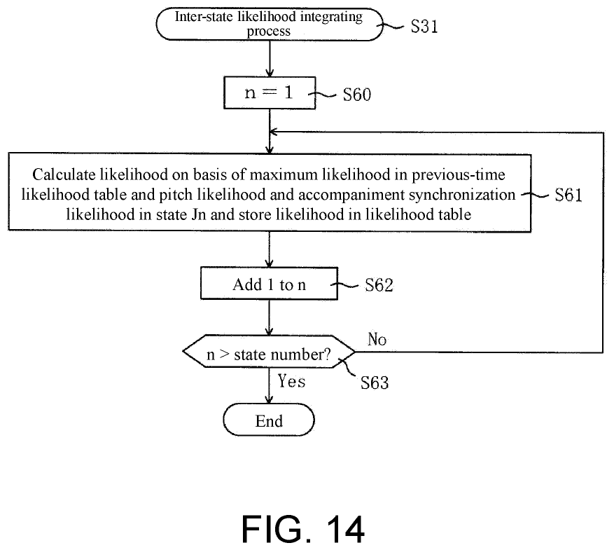

Description will return to FIG. 12. After the likelihood calculating process of S30, an inter-state likelihood integrating process is performed (S31). Here, the inter-state likelihood integrating process will be described with reference to FIG. 14.

FIG. 14 is a flowchart of the inter-state likelihood integrating process. This inter-state likelihood integrating process is a process for calculating a likelihood for each state Jn from each likelihood calculated in the likelihood calculating process represented in FIG. 13. In the inter-state likelihood integrating process, first, 1 is set to a counter variable n (S60). Hereinafter, “n” included in a “state Jn” in the inter-state likelihood integrating process represents the counter variable n, and, for example, in a case in which the counter variable n is 1, the state Jn represents a “state J1”.

After the process of S60, a likelihood of the state Jn is calculated on the basis of a maximum value of a likelihood stored in the previous-time likelihood table 12j, the pitch likelihood of the state Jn in the pitch likelihood table 12f, and the accompaniment synchronization likelihood of the state Jn in the accompaniment synchronization likelihood table 12g and is stored in the likelihood table 12i (S61). More specifically, when a maximum value of the likelihood stored in the previous-time likelihood table 12j is denoted by Lp_M, a pitch likelihood of the state Jn in the pitch likelihood table 12f is denoted by Pi_n, and an accompaniment synchronization likelihood of the state Jn in the accompaniment synchronization likelihood table 12g is denoted by B_n, a logarithmic likelihood log(L_n) that is a logarithm of the likelihood L_n of the state Jn is calculated using a Viterbi algorithm represented in Equation 3.

[Math 3]

log(L_n)=log(Lp_M)+log(Pi_n)+log(α·B_n) (Equation 3)

Here, α is a penalty constant for the accompaniment synchronization likelihood Bn, that is, a constant with a case in which a transition to the state Jn is not performed taken into account, and a value calculated in advance in an experiment or the like is set. A likelihood L_n acquired by excluding logarithm from the logarithmic likelihood log(L_n) calculated using Equation 3 is stored in a memory area corresponding to the state Jn in the likelihood table 12i.

The likelihood L_n is calculated by performing a product of the maximum value LpM of the likelihood stored in the previous-time likelihood table 12j, the pitch likelihood Pi_n, and the accompaniment synchronization likelihood Bn. Here, since each likelihood takes a value equal to or larger than 0 and equal to or smaller than 1, in a case in which such a product is performed, there is concern that an underf1ow may occur. Thus, by taking a logarithm of each of the likelihoods Lp_M, Pi_n, and B_n, calculation of a product of the likelihoods Lp_M, Pi_n, and B_b can be converted into calculation of a sum of logarithms of the likelihoods Lp_M, Pi_n, and B_b. Then, by calculating the likelihood L_n by excluding the logarithm of the logarithmic likelihood log(L_n) that is a calculation result thereof, a likelihood L-n with high accuracy in which an underf1ow is inhibited can be acquired.

After S61, 1 is added to the counter variable n (S62), and it is checked whether the counter variable n after addition is larger than the number of the states Jn (S63). In a case in which the counter variable n is equal to or smaller than the number of the states Jn in the process of S63, the processes of S61 and subsequent steps are repeated. On the other hand, in a case in which the counter variable n is larger than the number of states Jn (S63: Yes), the inter-state likelihood integrating process ends, and the process is returned to the input pattern search process represented in FIG. 12.

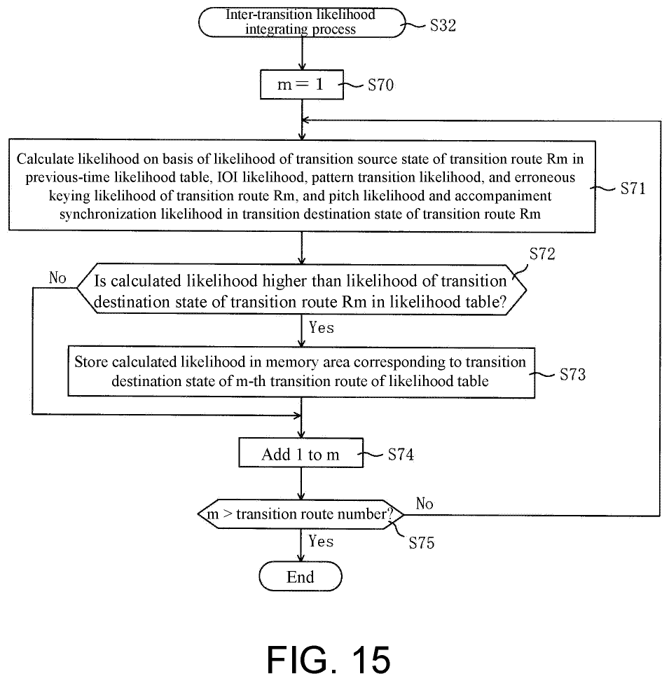

Description will return to FIG. 12. After the inter-state likelihood integrating process of S31, an inter-transition likelihood integrating process is performed (S32). The inter-transition likelihood integrating process will be described with reference to FIG. 15.

FIG. 15 is a flowchart of the inter-transition likelihood integrating process. The inter-transition likelihood integrating process is a process for calculating a likelihood of a state Jn of the transition destination of each transition route Rm on the basis of each likelihood calculated in the likelihood calculating process represented in FIG. 13 and the pattern transition likelihood and the erroneous keying likelihood, which are set in advance, stored in the inter-transition route likelihood table 11d.

In the inter-transition likelihood integrating process, first, 1 is set to a counter variable m (S70). Hereinafter, “m” included in a “transition route Rm” in the inter-transition likelihood integrating process represents the counter variable m, and, for example, a transition route Rm in a case in which the counter variable m is 1 represents a “transition route R1”.

After the process of S70, a likelihood is calculated on the basis of the likelihood of the state Jn of the transition source of the transition route Rm stored in the previous-time likelihood table 12j, the IOI likelihood of the transition route Rm stored in the IOI likelihood table 12h, the pattern transition likelihood and the erroneous keying likelihood stored in the inter-transition route likelihood table 11dx of the corresponding music genre, the pitch likelihood of the state Jn of the transition destination of the transition route Rm stored in the pitch likelihood table 12f, and the accompaniment synchronization likelihood of the state Jn of the transition destination of the transition route Rm stored in the accompaniment synchronization likelihood table 12g (S71).

More specifically, when the previous-time likelihood of the state Jn of the transition source of the transition route Rm stored in the previous-time likelihood table 12j is denoted by Lp_mb, the IOI likelihood of the transition route Rm stored in the IOI likelihood table 12h is denoted by I_m, the pattern transition likelihood stored in the inter-transition route likelihood table 11dx of the corresponding music genre is denoted by Ps_m, the erroneous keying likelihood stored in the inter-transition route likelihood table 11dx of the corresponding music genre is denoted by Ms_m, the pitch likelihood of the state Jn of the transition destination of the transition route Rm stored in the pitch likelihood table 12f is denoted by Pi_mf, and the accompaniment synchronization likelihood of the state Jn of the transition destination of the transition route Rm stored in the accompaniment synchronization likelihood table 12g is denoted by B_mf, the logarithmic likelihood log(L) that is a logarithm of the likelihood L is calculated using a Viterbi algorithm represented in Equation 4.

[Math 4]

log(L)=log(Lp_mb)+log(I_m)+log(Ps_m)+log(Ms_m)+log(Pi_mf)+log(B_mf) (Equation 4)

Here, the reason for calculating the logarithmic likelihood log(L) using a sum of logarithmic likelihoods Lp_mb, I_m, Ps_m, Ms_m, Pi_mf, and B_mf in Equation 4 is, similar to Equation 3 represented above, for inhibiting an underf1ow of the likelihood L. Then, by excluding the logarithm from the logarithmic likelihood log(L) calculated in such Equation 4, the likelihood L is calculated.

After the process of S71, it is checked whether the likelihood L calculated in the process of S70 is larger than the likelihood of the state Jn of the transition destination of the transition route Rm stored in the likelihood table 12i (S72). In a case in which the likelihood L calculated in the process of S70 is larger than the likelihood of the state Jn of the transition destination of the transition route Rm stored in the likelihood table 12i in the process of S72, the likelihood L calculated in the process of S70 is stored in a memory area corresponding to the state Jn of the transition destination of the transition route Rm in the likelihood table 12i (S73).

On the other hand, in a case in which the likelihood L calculated in the process of S70 is equal to or smaller than the likelihood of the state Jn of the transition destination of the transition route Rm stored in the likelihood table 12i in the process of S72 (S72: No), the process of S73 is skipped.

After the processes of S72 and S73, 1 is added to the counter variable m (S74), then, it is checked whether the counter variable m is larger than the number of transition routes Rm (S75). In the process of S75, in a case in which the counter variable m is equal to or smaller than the number of the transition routes Rm (S75: No), the processes of S71 and subsequent steps are repeated, and in a case in which the counter variable m is larger than the number of the transition routes Rm (S75: Yes), the inter-transition likelihood integrating process ends, and the process is returned to the input pattern search process illustrated in FIG. 12.

In other words, in the inter-transition likelihood integrating process, a likelihood of the state Jn of the transition destination of the transition route Rm is calculated using the previous-time likelihood Lp_mb of the state Jn of the transition source of the transition route Rm stored in the previous-time likelihood table 12j as a reference. The reason for this is that a transition of the state Jn depends on the state Jn of the transition source. In other words, a probability of the state Jn of which the previous-time likelihood Lp_mb is high being the state Jn of the transition source of this time is estimated to be high, and on the other hand, a probability of the state Jn of which the previous-time likelihood Lp_mb is low being the state Jn of the transition source of this time is estimated to be low. Thus, by calculating a likelihood of the state Jn of the transition destination of the transition route Rm using the previous-time likelihood Lp_mb as a reference, a likelihood having high accuracy with a transition relation between states Jn taken into account can be acquired.

On the other hand, the likelihood calculated in the inter-transition likelihood integrating process depends on a transition relation between the states Jn, and thus, for example, a case in which the state Jn of the transition source and the state Jn of the transition destination do not correspond to the input pattern table 11bx of the corresponding music genre like a case in which musical performance information of the keyboard 2 is input immediately after start of musical performance of an accompaniment, a case in which an input interval of musical performance information of the keyboard 2 is extremely long, or the like may be considered. In such a case, all the likelihoods calculated in the inter-transition likelihood integrating process on the basis of a transition relation between the states Jn have small values.

Here, in the inter-state likelihood integrating process described above with reference to FIG. 14, a likelihood is calculated on the basis of the pitch likelihood and the accompaniment synchronization likelihood set for each state Jn and thus does not depend on the transition route Rm. Thus, in a case in which the states do not correspond to the state Jn of the transition source and the state Jn of the transition destination stored in the input pattern table 11bx of the corresponding music genre, a likelihood of the state Jn calculated in the inter-state likelihood integrating process is higher than the likelihood of the state Jn calculated in the inter-transition likelihood integrating process. In this case, the likelihoods calculated in the inter-state likelihood integrating process remains to be stored in the likelihood table 12i.

Thus, by combining calculation of a likelihood based on the previous-time likelihood Lp_mb according to the inter-transition likelihood integrating process and a likelihood based on the musical performance information of the key 2a at the time point according to the inter-state likelihood integrating process, even in a case there is a transition relation between the states Jn and a case in which a transition relation is insufficient, a likelihood of the state Jn can be appropriately calculated in accordance with each of the cases.

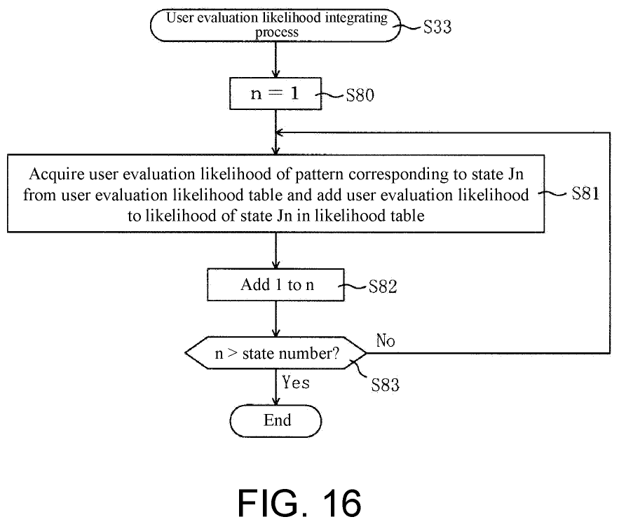

Description will return to FIG. 12. After the inter-transition likelihood integrating process of S32, a user evaluation likelihood integrating process is performed (S33). Here, the user evaluation likelihood integrating process will be described with reference to FIG. 16.

FIG. 16 is a flowchart of the user evaluation likelihood integrating process. In the user evaluation likelihood integrating process, first, 1 is set to a counter variable n (S80). Hereinafter, also in the user evaluation likelihood integrating process, similar to the inter-state likelihood integrating process represented in FIG. 14, “n” included in “state Jn” represents the counter variable n. For example, in a case in which the counter variable n is 1, the state Jn represents a “state J1”.

After the process of S80, a user evaluation likelihood of a pattern corresponding to the state Jn is acquired from the user evaluation likelihood table 11e and is added to the likelihood of the state Jn stored in the likelihood table 12i (S81). After the process of S81, 1 is added to the counter variable n (S82), and it is checked whether the counter variable n is larger than a total number of states Jn (S83). In the process of S83, in a case in which the counter variable n is equal to or smaller than the total number of states Jn (S83: No), the processes of S81 and subsequent steps are repeated. On the other hand, in a case in which the counter variable n is larger than the total number of states Jn (S83: Yes), the user evaluation likelihood integrating process ends, and the process is returned to the input pattern search process represented in FIG. 12.

In accordance with the user evaluation likelihood integrating process, the user evaluation likelihood is reflected in the likelihood table 12i. In other words, a performer's evaluation of an output pattern is reflected in the likelihood table 12i. Thus, when the state Jn of the output pattern receives a higher evaluation from the performer, the likelihood in the likelihood table 12i becomes higher, and the estimated output pattern can be configured to be in accordance with the performer's evaluation.

The description will return to FIG. 12. After the user evaluation integrating process of S33, a state Jn taking a likelihood having the maximum value in the likelihood table 12i is acquired, and a pattern corresponding to the state Jn is acquired from the input pattern table 11bx of the corresponding music genre and is stored in the selected pattern memory 12b (S34). In other words, a maximum likelihood state Jn for the musical performance information from the key 2a is acquired from the likelihood table 12i, and a pattern corresponding to the state Jn is acquired. In accordance with this, a maximum likelihood pattern for the musical performance information from the key 2a can be selected.

After the process of S34, it is checked whether a likelihood having a maximum value in the likelihood table 12i has been updated in the inter-transition likelihood integrating process of S32 (S35). In other words, it is checked whether the likelihood of the state Jn used for determining a pattern in the process of S34 has been updated using a likelihood based on the previous-time likelihood Lp_mb according to the processes of S71 to S73 represented in FIG. 15.

In the process of S35, in a case in which a likelihood having a maximum value in the likelihood table 12i has been updated in the inter-transition likelihood integrating process (S35: Yes), a transition route Rm of this time is acquired on the basis of the state Jn taking the likelihood having the maximum value in the likelihood table 12i and the state Jn taking the likelihood having the maximum value in the previous-time likelihood table 12j and is stored in the transition route memory 12c (S36). More specifically, a state Jn taking a likelihood having the maximum value in the likelihood table 12i and a state Jn taking a likelihood having the maximum value in the previous-time likelihood table 12j are retrieved using the state Jn of the transition destination and the state Jn of the transition source in the inter-transition route likelihood table 11dx of the corresponding music genre, and a transition route Rm matching these states Jn is acquired from the inter-transition route likelihood table 11dx of the corresponding music genre and is stored in the transition route memory 12c.

After the process of S36, a tempo is calculated on the basis of a beat distance in the transition route Rm of the transition route memory 12c and the keying interval stored in the IOI memory 12e and is stored in the tempo memory 12d (S37). More specifically, a beat distance in the transition route Rm stored in the inter-transition route likelihood table 11dx of the corresponding music genre that matches the transition route Rm stored in the transition route memory 12c is denoted by Δτ, the keying interval stored in the IOI memory 12e is denoted by x, and the current tempo stored in the tempo memory 12d is denoted by Vmb, the tempo Vm after the update is calculated using Equation 5.

$$\begin{matrix}[ Math 5 ] & \\ Vm = γ \cdot \frac{x}{Δ τ} + ( 1 - γ ) \cdot Vmb & ( Equation 5 )\end{matrix}$$

Here, γ is a constant satisfying 0<γ<1 and is a value set in advance through an experiment or the like.

In other words, since the likelihood having the maximum value in the likelihood table 12i, which has been used for determining the pattern in the process of S34, is updated in the inter-transition likelihood integrating process of S32, inputs of the previous time and this time using the key 2a are estimated to be a transition in the transition route Rm between the state Jn taking the likelihood having the maximum value in the previous-time likelihood table 12j and the state Jn taking the likelihood having the maximum value in the likelihood table 12i.

Thus, by changing the tempo of the accompaniment sound from the beat distance of the transition route Rm and the keying interval according to inputs of the previous time and this time using the key 2a, an accompaniment sound for which there is a little strange feeling based on the keying interval of the key 2a according to an actual performer can be formed.

In the process of S35, in a case in which the likelihood having the maximum value in the likelihood table 12i has not been updated in the inter-transition likelihood integrating process (S35: No), the processes of S36 and S37 are skipped. In other words, in such a case, the likelihood having the maximum value in the likelihood table 12i is calculated in the inter-state integrating process of S31, and thus it is estimated that the state Jn taking the likelihood having the maximum value does not depend on the transition route Rm.

In such a case, even when a search for a transition route Rm using the state Jn of S36 is performed, there is concern that a matching transition route Rm may be not able to be acquired, or even when the transition route Rm was able to be acquired, there is concern that an incorrect transition route Rm may be acquired. Even when the tempo updating process of S37 is performed in a state in which such a transition route Rm is not able to be correctly acquired, there is concern that the calculated tempo may be inaccurate. Thus, in a case in which the likelihood having the maximum value in the likelihood table 12i has not been updated in the inter-transition likelihood integrating process, by skipping the processes of S36 and S37, an application of an incorrect tempo to the accompaniment sound can be inhibited.

After the processes of S35 and S37, the value of the likelihood table 12i is set in the previous-time likelihood table 12j (S38), and after the process of S38, the input pattern search process ends, and the process is returned to the key input process represented in FIG. 11.

The description will return to FIG. 11. After the input pattern search process of S7, the accompaniment sound is changed on the basis of the pattern stored in the selected pattern memory 12b and the output pattern table 11cx of the corresponding music genre (S8). More specifically, the accompaniment sound is changed on the basis of the drum pattern, the bass pattern, the chord progression, and the arpeggio progression corresponding to the pattern stored in the selected pattern memory 12b in the output pattern table 11cx of the corresponding music genre. At this time, in a case in which the tempo has been updated in the process of S37 in the input pattern search process (FIG. 12), the tempo of the accompaniment sound is also set to the updated tempo of the tempo memory 12d.

In other words, every time musical performance information from the key 2a is input, a maximum likelihood state Jn for the musical performance information is estimated, and an accompaniment sound and an effect according to an output pattern corresponding to the state Jn are output. Thus, in accordance with free musical performance of a performer, an accompaniment sound and an effect conforming to the musical performance can be output through switching. Furthermore, a performer's operation on the synthesizer 1 for such switching is not necessary, and thus the usability of the synthesizer 1 for the performer is improved, and the performer can focus more on a musical performance operation using the key 2a and the like.

In the process of S101, in a case in which the accompaniment change setting is off (S101: No), the processes of S7 and S8 are skipped. After the processes of S8 and S101, a musical sound is output on the basis of the musical performance information of the key 2a (S9), and the key input process ends. At this time, a tone of a musical sound based on the musical performance information of the key 2a is regarded to be a tone corresponding to the pattern stored in the selected pattern memory 12b in the output pattern table 11cx of the corresponding music genre, and volume/velocity and an effect corresponding to the pattern of the selected pattern memory 12b in the output pattern table 11cx of the corresponding music genre are applied to such a musical sound, and a resultant musical sound is output. The effect on the musical sound based on the musical performance information of the key 2a is applied by processing waveform data of such a musical sound output from the sound source 13 using the DSP 14.

In addition, in a case in which the accompaniment change setting is on, in accordance with the input pattern search process of S7 and the process of S8, the rhythm and the pitch of the accompaniment sound change at any time in accordance with musical performance information from the key 2a. On the other hand, in a case in which the accompaniment change setting is off, the processes of S7 and S8 are skipped, and thus even when the musical performance information from the key 2a is changed, the rhythm and the pitch of the accompaniment sound do not change. In accordance with this, by changing the accompaniment change setting in accordance with a performer's intention, an accompaniment sound in a form conforming to the performer's musical performance can be output.

Furthermore, in a case in which the accompaniment change setting is on, by changing the calculated likelihood on the basis of the rhythm change setting and the pitch change setting in the likelihood calculating process represented in FIG. 13, the form of the accompaniment sound can be changed more finely.

More specifically, in a case in which the rhythm change setting is on in FIG. 13, the IOI likelihood table 12h and the accompaniment synchronization likelihood table 12g relating to the rhythm for the input to the key 2a, that is, the keying interval and the beat position are updated, and thus, switching between rhythms of the accompaniment sound can be performed in accordance with the musical performance information of the key 2a. On the other hand, in a case in which the rhythm change setting is off, the IOI likelihood table 12h and the accompaniment synchronization likelihood table 12g relating to the rhythm are not updated, and thus the rhythm of the accompaniment sound is fixed regardless of the musical performance information of the key 2a. In accordance with this, a musical sound corresponding to the key 2a can be output in accordance with the process of S9 in a state in which the rhythm of the accompaniment sound is fixed, and thus musical performance that is expressive in the rhythm of the accompaniment sound can be performed, for example, musical performance according to the key 2a can be performed by intentionally being out of a timing from the rhythm of the accompaniment sound or the like.

In addition, in a case in which the pitch change setting is on, the pitch likelihood table 12f relating to the pitch of the key 2a is updated, and thus chord progression of the accompaniment sound is changed in accordance with the musical performance information of the key 2a, and the pitch of the accompaniment sound can be changed. On the other hand, in a case in which the pitch change setting is off, the pitch likelihood table 12f is not updated, and thus the chord progression of the accompaniment sound is fixed regardless of the musical performance information of the key 2a. In accordance with this, a musical sound corresponding to the key 2a can be output in a state in which the chord progression of the accompaniment sound is fixed, and thus, for example, in a case in which solo musical performance is performed using a musical sound corresponding to the key 2a, musical performance that is expressive in the chord progression of the accompaniment sound can be performed such as configuring the solo musical performance to be distinguished due to no change in the chord progression of the accompaniment sound or the like.

Furthermore, the accompaniment change setting, the rhythm change setting, and the pitch change setting described above are set using the setting key 50 (FIGS. 1 and 2). In accordance with this, by appropriately setting the accompaniment change setting, the rhythm change setting, and the pitch change setting by operating the setting key 50 in accordance with the performer's intention during musical performance, the form of the accompaniment sound can be changed easily and quickly.

Description will return to FIG. 9. After the key input process of S100, the processes of S5 and subsequent steps are repeated.

In addition, in a case in which there is no input of musical performance information from the key 2a in the process of S6 (S6: No), it is further checked whether there has been no input of musical performance information from the key 2a for six bars or more (S10). In a case in which there has been no input of musical performance information from the key 2a for six bars or more in the process of S10 (S10: Yes), the process proceeds to an ending part of the corresponding music genre (S11). In other words, in a case in which there has been no musical performance of the performer for 6 bars or more, it is estimated that the musical performance has ended. In such a case, by proceeding to the ending part of the corresponding music genre, the performer can cause the process to proceed to the ending part without operating the synthesizer 1.

After the process of S11, during the play of the ending pattern, it is checked whether there has been an input of musical performance information from the key 2a (S12). In the process of S12, in a case in which there has been an input of musical performance information from the key 2a, it is estimated that the performer's musical performance has resumed, and thus the process proceeds to the accompaniment sound immediately before the transition to the ending part from the ending part (S14), and a musical sound is output on the basis of the musical performance information of the key 2a (S15). After the process of S15, the processes of S5 and subsequent steps are repeated.

In a case in which there has been no input of musical performance information from the key 2a during the musical performance of the ending part in the process of S12 (S12: No), the end of the musical performance of the ending part is checked (S13). In a case in which the musical performance of the ending part has ended in the process of S13 (S13: Yes), it is estimated that the performer's musical performance has completely ended, and thus the processes of S1 and subsequent steps are repeated. On the other hand, in a case in which the musical performance of the ending part has not ended in the process of S13 (S13: No), the processes of S12 and subsequent steps are repeated.

As above, although the description has been presented on the basis of the embodiment described above, it can be easily assumed that various modifications and changes can be performed.

In the embodiment described above, the synthesizer 1 has been illustrated as an automatic musical performance device. However, the automatic musical performance device is not necessarily limited thereto and may be applied to an electronic instrument that outputs an accompaniment sound and an effect together with a musical sound according to musical performance of a performer such as an electronic organ or an electronic piano.

In the embodiment described above, as output patterns, the drum pattern, the bass pattern, the chord progression, the arpeggio progression, the effect, the volume/velocity, and the tone are set. However, the output patterns are not necessarily limited thereto, and musical expressions other than the drum pattern, the bass pattern, the chord progression, the arpeggio progression, the effect, the volume/velocity, and the tone, for example, a rhythm pattern other than a drum and a bass and voice data such as a singing voice of a person may be configured to be added to the output patterns.

In the embodiment described above, in switching between output patterns, a configuration in which switching of all the drum pattern, the bass pattern, the chord progression, the arpeggio progression, the effect, the volume/velocity, and the tone of the output patterns is performed has been employed. However, the switching is not necessarily limited thereto, and a configuration in which switching of only some of the drum pattern, the bass pattern, the chord progression, the arpeggio progression, the effect, the volume/velocity, and the tone of the output patterns (for example, only the drum pattern and the chord progression) is performed may be employed.

Furthermore, a configuration in which an element of an output pattern that is a switching target is set in advance in each output pattern, and switching of only the set output pattern is performed in switching of output patterns may be employed. In accordance with this, an output pattern according to the performer's preference can be formed.

In the embodiment described above, three modes of the accompaniment change setting, the rhythm change setting, and the pitch change setting are provided. However, the modes are not limited thereto, and one or two modes may be omitted from the three modes. In such a case, in a case in which the accompaniment change setting is omitted, the key input process represented in FIG. 11 to the process of S101 may be omitted. In a case in which the rhythm change setting is omitted, the likelihood calculating process represented in FIG. 13 to the process of S110 may be omitted. In a case in which the pitch change setting is omitted, the likelihood calculating process represented in FIG. 13 to the process of S111 may be omitted.

In the embodiment described above, in the processes of S52 and S53 illustrated in FIG. 13, the pitch likelihood and the accompaniment synchronization likelihood are configured to be calculated for all the states Jn. However, the configuration is not necessarily limited thereto, and the pitch likelihood and the accompaniment synchronization likelihood may be configured to be calculated for some of the states Jn. For example, in a transition route Rm having a state Jn taking a likelihood having the maximum value in the previous-time likelihood table 12j as the state Jn of a transition source, the pitch likelihood and the accompaniment synchronization likelihood may be configured to be calculated only for a state Jn that is a state Jn of a transition destination.

In the embodiment described above, a musical performance time of an accompaniment sound in each output pattern is a length corresponding to two bars in the four-four time. However, the length is not necessarily limited thereto, and the musical performance time of the accompaniment sound may correspond to one bar or three or more bars. In addition, the time per bar in the accompaniment sound is not limited to the four-four time, and another time such as a three four time or six eight time may be configured to be appropriately used.

In the embodiment described above, a transition route according to sound skipping for transitioning from a state Jn that is before two states as a transition route to the state Jn between the same patterns is configured to be set. However, the configuration is not necessarily limited thereto, and a configuration in which a transition route transitioning from a state Jn that is before three or more states between the same patterns is included as a transition route according to sound skipping may be employed. In addition, a transition route according to sound skipping may be configured to be omitted from the transition route to the state Jn between the same patterns.

In addition, in the embodiment described above, as a transition route to the state Jn between different patterns, a transition route in which a state Jn of the different pattern that is the transition source thereof is immediately before the beat position of the state Jn of the transition destination is configured to be set. However, the configuration is not necessarily limited thereto, and also for a transition route to the state Jn between different patterns, a transition route according to sound skipping transitioning from a state Jn, which is a transmission source, that is two or more states before the beat position of the state Jn of the transition destination in a different pattern may be configured to be set as well.

In the embodiment described above, the IOI likelihood G is configured to follow the Gaussian distribution represented in Equation 1, and the accompaniment synchronization likelihood B is configured to follow the Gaussian distribution represented in Equation 2. However, the configuration is not necessarily limited thereto, and the IOI likelihood G may be configured to follow a different probability distribution function such as a Laplace distribution.

In the embodiment described above, in the process of S61 illustrated in FIG. 14, the likelihood L_n acquired by excluding the logarithm from the logarithmic likelihood log (L_n) calculated using Equation 3 is configured to be stored in the likelihood table 12i, and, in the processes of S71 to S73 illustrated in FIG. 15, the likelihood L acquired by excluding the logarithm from the logarithmic likelihood log(L) calculated using Equation 4 is configured to be stored in the likelihood table 12i. However, the configuration is not necessarily limited thereto, and the logarithmic likelihood log (L_n) or the logarithmic likelihood log(L) calculated using Equation 3 or 4 may be configured to be stored in the likelihood table 12i, and selection of a pattern in the process of S34 illustrated in FIG. 12 and update of a tempo in the processes of S35 to S37 may be configured to be performed on the basis of the logarithmic likelihood log (L_n) or the logarithmic likelihood log(L) stored in the likelihood table 12i.

In the embodiment described above, every time musical performance information from the keyboard 2 is input, estimation of the state Jn and the pattern and switching of the output pattern to the estimated pattern are configured to be performed. However, the configuration is not necessarily limited thereto, and estimation of the state Jn and the pattern and the switching of the output pattern to the estimated pattern may be configured to be performed on the basis of the musical performance information that is within a predetermined time (for example, two bars or four bars). In accordance with this, switching of the output pattern is performed at least every predetermined time, and thus a situation in which the output pattern, that is, an accompaniment sound and an effect are frequently changed is inhibited, and an accompaniment sound and an effect for which a performer and the audience have no strange feeling can be formed.

In the embodiment described above, the musical performance information is configured to be input from the keyboard 2. However, instead of this, a configuration in which an external keyboard according to the MIDI standards is connected to the synthesizer 1, and musical performance information is input from such a keyboard may be employed.

In the embodiment described above, the accompaniment sound and the musical sound are configured to be output from the sound source 13, the DSP 14, the DAC 16, the amplifier 17, and the speaker 18 disposed in the synthesizer 1. However, instead of this, a configuration in which a sound source device according to the MIDI standards is connected to the synthesizer 1, and the accompaniment sound and the musical sound of the synthesizer 1 are output from such as sound source device may be employed.

In the embodiment described above, a performer's evaluation of the accompaniment sound and the effect is configured to be performed using the user evaluation button 3. However, instead of this, a configuration in which a sensor detecting biological information of a performer, for example, a brain wave sensor (one example of a brain wave detecting part) detecting a brain wave of a performer, a brain blood flow sensor detecting a brain blood flow of a performer, or the like is connected to the synthesizer 1, and the performer's evaluation is performed by estimating an impression of the performer for an accompaniment sound and an effect on the basis of the biological information may be employed.

In addition, a configuration in which a motion sensor (one example of a motion detecting part) detecting a motion of a performer is connected to the synthesizer 1, and the performer's evaluation is performed in accordance with a specific motion, a wave of the hand, or the like of the performer that is detected from the motion sensor may be employed. In addition, a configuration in which an expression sensor (one example of an expression detecting part) detecting an expression of a performer is connected to the synthesizer 1, and the performer's evaluation is performed in accordance with a specific expression of the performer, which is detected from the expression sensor, that is an expression of a performer indicating a good impression or a bad impression, for example, a smiling face, a dissatisfied expression, or the like, a change in the expression, or the like may be employed. In addition, a configuration in which a posture sensor (one example of a posture detecting part) detecting a posture of a performer is connected to the synthesizer, and the performer's evaluation is performed in accordance with a specific posture (a forward inclined posture or a backward inclined posture) of a performer or a change in the posture that is detected from the posture sensor may be employed.

Furthermore, a configuration in which a camera obtaining an image of a performer is connected to the synthesizer 1 instead of the motion sensor, the expression sensor, or the posture sensor, the performer's evaluation is performed by detecting a motion, an expression, or a posture of the performer by analyzing the image obtained from the camera may be employed. By performing the performer's evaluation in accordance with a detection result from the sensor detecting biological information, the motion sensor, the expression sensor, the posture sensor, or the camera, the performer can evaluate an accompaniment sound and an effect without operating the user evaluation button 3, and thus the operability for the synthesizer 1 can be improved.

In the embodiment described above, a user evaluation likelihood is configured as a performer's evaluation for an accompaniment sound and an effect. However, the configuration is not necessarily limited thereto, and the user evaluation likelihood may be configured to be an evaluation of the audience for an accompaniment sound and an effect or may be configured to be evaluations of the performer and the audience for an accompaniment sound and an effect. In such a case, a configuration in which a remote control device used for transmitting a high evaluation or a low evaluation of an accompaniment sound and an effect to the synthesizer 1 is held by the audience, and the user evaluation likelihood is calculated on the basis of the number of the high evaluations and the low evaluations from the remote control devices may be employed. In addition, a configuration in which a microphone is arranged in the synthesizer 1, and the user evaluation likelihood is calculated on the basis of the magnitude of glad shouts from the audience may be employed.

In the embodiment described above, the control program 11a is configured to be stored in the flash ROM 11 of the synthesizer 1 and operate on the synthesizer 1. However, the configuration is not necessarily limited thereto, and the control program 11a may be configured to operate on another computer such as a personal computer (PC), a mobile phone, a smartphone, or a tablet terminal. In this case, instead of the keyboard 2 of the synthesizer 1, musical performance information may be configured to be input from a keyboard of the MIDI standards or a keyboard used for inputting characters connected to the PC or the like in a wired or wireless manner, or musical performance information may be configured to be input from a software keyboard displayed in a display device of the PC or the like.

The numerical values described in the embodiment described above are examples, and it is apparent that different numerical values may be employed.

### REFERENCE SIGNS LIST

1 synthesizer (automatic musical performance device)

2 keyboard (input part)

3 user evaluation button (evaluation input part)

11a control program (automatic musical performance program)

11b input pattern table (a portion of storage part)

11c output pattern table (a portion of storage part)

50 setting key (setting part)

S4 musical performance part

S8 musical performance part, switching part

S34 selection part

S51 to S53 likelihood calculating part

1. An automatic musical performance device comprising:
a storage part configured to store a plurality of musical performance patterns;
a musical performance part configured to perform musical performance on the basis of the plurality of musical performance patterns stored in the storage part;
an input part to which musical performance information is input from an input device receiving a musical performance operation of a performer;
a setting part configured to set a mode as to whether to switch the musical performance by the musical performance part;
a selection part configured to select a musical performance pattern estimated to have a maximum likelihood among the plurality of musical performance patterns stored in the storage part on the basis of the musical performance information input to the input part in a case in which a mode of switching the musical performance by the musical performance part is set by the setting part; and
a switching part configured to switch at least one musical expression of the musical performance pattern played by the musical performance part to a musical expression of the musical performance pattern selected by the selection part.

2. The automatic musical performance device according to claim 1,
wherein the selection part comprises a likelihood calculating part that calculates a likelihood of each of all or some of musical sounds composing the plurality of musical performance patterns stored in the storage part on the basis of the musical performance information input to the input part in the case in which the mode of switching the musical performance by the musical performance part is set by the setting part, and
wherein one musical performance pattern among the plurality of musical performance patterns stored in the storage part is estimated to have a maximum likelihood on the basis of the likelihood calculated by the likelihood calculating part.

3. The automatic musical performance device according to claim 2, wherein, in a case in which a mode of switching a pitch of the musical performance by the musical performance part is set by the setting part, the likelihood calculating part calculates a likelihood of each of all or some of musical sounds composing the plurality of musical performance patterns stored in the storage part on the basis of a pitch of the musical performance information input to the input part.

4. The automatic musical performance device according to claim 2, wherein, in a case in which a mode of switching a rhythm of the musical performance by the musical performance part is set by the setting part, the likelihood calculating part calculates a likelihood of each of all or some of musical sounds composing the plurality of musical performance patterns stored in the storage part on the basis of a beat position of the musical performance information input to the input part.

5. The automatic musical performance device according to claim 2, wherein, in a case in which a mode of switching a rhythm of the musical performance by the musical performance part is set by the setting part, the likelihood calculating part calculates a likelihood of another musical sound being produced after one musical sound for each of all or some of musical sounds composing the plurality of musical performance patterns stored in the storage part on the basis of an input interval between the musical performance information of a previous time and the musical performance information of this time input to the input part.

6. The automatic musical performance device according to claim 1, wherein the setting part is configured to be able to change a setting state during the musical performance of the performer.

7. A non-transitory computer readable medium storing an automatic musical performance program causing a computer comprising a storage to execute automatic musical performance,
the storage being caused to function as a storage part configured to store a plurality of musical performance patterns, wherein the automatic musical performance program causes the computer to realize:
a performing step of performing musical performance on the basis of the plurality of musical performance patterns stored in the storage part;
an inputting step in which musical performance information is input from an input device receiving a musical performance operation of a performer;
a setting step of setting a mode as to whether to switch the musical performance by the performing step;
a selecting step of selecting a musical performance pattern estimated to have a maximum likelihood among the plurality of musical performance patterns stored in the storage part on the basis of the musical performance information input by the inputting step in a case in which a mode of switching the musical performance by the performing step is set by the setting step; and
a switching step of switching at least one musical expression of the musical performance pattern played by the performing step to a musical expression of the musical performance pattern selected by the selecting step.

8. The non-transitory computer readable medium according to claim 7, wherein
the selecting step comprises a likelihood calculating step in which a likelihood of each of all or some of musical sounds composing the plurality of musical performance patterns stored in the storage part is calculated on the basis of the musical performance information input by the inputting step in the case in which the mode of switching the musical performance by the performing step is set by the setting step, and
one musical performance pattern among the plurality of musical performance patterns stored in the storage part is estimated to have a maximum likelihood on the basis of the likelihood calculated by the likelihood calculating step.

9. The non-transitory computer readable medium according to claim 8, wherein
in a case in which a mode of switching a pitch of the musical performance by the performing step is set by the setting step, in the likelihood calculating step, a likelihood of each of all or some of musical sounds composing the plurality of musical performance patterns stored in the storage part is calculated on the basis of a pitch of the musical performance information input by the inputting step.

10. The non-transitory computer readable medium according to claim 8, wherein
in a case in which a mode of switching a rhythm of the musical performance by the performing step is set by the setting step, in the likelihood calculating step, a likelihood of each of all or some of musical sounds composing the plurality of musical performance patterns stored in the storage part is calculated on the basis of a beat position of the musical performance information input by the inputting step.

11. The non-transitory computer readable medium according to claim 8, wherein
in a case in which a mode of switching a rhythm of the musical performance by the performing step is set by the setting step, in the likelihood calculating step, a likelihood of another musical sound being produced after one musical sound is calculated for each of all or some of musical sounds composing the plurality of musical performance patterns stored in the storage part on the basis of an input interval between the musical performance information of a previous time and the musical performance information of this time input by the inputting step.

12. The non-transitory computer readable medium according to claim 7, wherein
the setting step is configured to be able to change a setting state during the musical performance of the performer.

13. An automatic musical performance method for use in an automatic musical performance device comprising a storage part configured to store a plurality of musical performance patterns, the automatic musical performance method comprising:
performing musical performance on the basis of the plurality of musical performance patterns stored in the storage part;
receiving musical performance information as input from an input device receiving a musical performance operation of a performer;
setting a mode as to whether to switch the musical performance by the performing;
selecting a musical performance pattern estimated to have a maximum likelihood among the plurality of musical performance patterns stored in the storage part on the basis of the musical performance information received as input in a case in which a mode of switching the musical performance by the performing is set by the setting; and
switching at least one musical expression of the musical performance pattern played by the performing to a musical expression of the musical performance pattern selected by the selecting.

14. The automatic musical performance device according to claim 3, wherein, in a case in which a mode of switching a rhythm of the musical performance by the musical performance part is set by the setting part, the likelihood calculating part calculates a likelihood of each of all or some of musical sounds composing the plurality of musical performance patterns stored in the storage part on the basis of a beat position of the musical performance information input to the input part.

15. The automatic musical performance device according to claim 3, wherein, in a case in which a mode of switching a rhythm of the musical performance by the musical performance part is set by the setting part, the likelihood calculating part calculates a likelihood of another musical sound being produced after one musical sound for each of all or some of musical sounds composing the plurality of musical performance patterns stored in the storage part on the basis of an input interval between the musical performance information of a previous time and the musical performance information of this time input to the input part.

16. The automatic musical performance device according to claim 4, wherein, in the case in which the mode of switching the rhythm of the musical performance by the musical performance part is set by the setting part, the likelihood calculating part calculates a likelihood of another musical sound being produced after one musical sound for each of all or some of musical sounds composing the plurality of musical performance patterns stored in the storage part on the basis of an input interval between the musical performance information of a previous time and the musical performance information of this time input to the input part.

17. The automatic musical performance device according to claim 2, wherein the setting part is configured to be able to change a setting state during the musical performance of the performer.

18. The automatic musical performance device according to claim 3, wherein the setting part is configured to be able to change a setting state during the musical performance of the performer.

19. The automatic musical performance device according to claim 4, wherein the setting part is configured to be able to change a setting state during the musical performance of the performer.

20. The automatic musical performance device according to claim 5, wherein the setting part is configured to be able to change a setting state during the musical performance of the performer.
